(19) United States
(12) Patent Application Publication
(10) Pub. No.: US 2025/0005847 A1
(43) Pub. Date: Jan. 2, 2025

(54) SYSTEMS AND METHODS FOR USE IN FILMING

(71) Applicant: FD IP & LICENSING LLC, Los Angeles, CA (US)

(72) Inventors: Brandon FAYETTE, Los Angeles, CA (US); Gene REDDICK, San Francisco, CA (US)

(21) Appl. No.: 18/739,852

(22) Filed: Jun. 11, 2024

Related U.S. Application Data
(60) Provisional application No. 63/510,465, filed on Jun. 27, 2023.
(60) Provisional application No. 63/606,804, filed on Dec. 6, 2023.

(51) Int. Cl. G06T 15/20; G06T 13/40; G06T 17/00; G06T 19/00

(52) U.S. Cl. CPC G06T 15/205; G06T 13/40; G06T 17/00; G06T 19/006

(57) ABSTRACT

Example systems and methods for filming are disclosed. In an example, prop spatial data for a prop device and digital asset spatial data for a virtual asset can be received. The digital asset's spatial data can be updated based on the prop data, adjusting its position, movement, and orientation in a virtual space. In some examples, a scene model, a virtual representation of a scene, can be created using depth and color data. A miniaturized diorama of the scene model can be generated. A virtual camera can be configured to provide a perspective view of the diorama, visualized on an output device. In some examples, the scene model can include virtual points corresponding to scene locations, creating a waypoint scene model. Augmented video data can incorporate these virtual points based on the waypoint scene model. The waypoint scene model can also be miniaturized to provide the diorama.

### RELATED APPLICATIONS

This application claims the benefit and priority of U.S. Provisional Application No. 63/510,465, titled “SYSTEMS AND METHODS FOR USE IN SCENE PREVISUALIZATION,” filed Jun. 27, 2023, and U.S. Provisional Application No. 63/606,804, titled “SYSTEM AND METHOD FOR DIGITAL PROP TRACKING,” filed Dec. 6, 2023, each of which is incorporated herein by reference in its entirety.

### FIELD OF THE DISCLOSURE

This disclosure relates generally to filmmaking.

### BACKGROUND OF THE DISCLOSURE

Previsualization, often abbreviated as previs, is a process used in filmmaking, animation, and other visual media industries to create a preliminary visual representation of a planned scene or sequence. It involves creating simplified or rough versions of the intended shots, using storyboards, 3D computer graphics, or other visual aids. Alternative techniques have been developed to traditional previs techniques for scene visualization. Previsualization systems have been developed to allow a director to have a “good enough” shot of a scene with digital assets. Such systems enable the director to visualize the scene with animated (or still) digital assets using compositing techniques. Prior to the development of previsualization systems, directors filmed the scene without the digital asset, and a post production team (or individual) was used to insert the digital assets to allow the producer to visualize a shot of the scene with the digital asset.

Compositing is a process or technique of combining visual elements from separate sources into single images, often to create an illusion that all those elements are parts of the same scene. Today, most, though not all, compositing is achieved through digital image manipulation. All compositing involves replacement of selected parts of an image with other material, usually, but not always, from another image. In a digital method of compositing, software commands designate a narrowly defined color as the part of an image to be replaced. Then the software replaces every pixel within the designated color range with a pixel from another image, aligned to appear as part of the original. Visual effects (sometimes abbreviated as VFX) is the process by which imagery is created or manipulated outside the context of a live-action shot in filmmaking and video production. VFX involves the integration of live-action footage (which may include in-camera special effects) and other live-action footage or computer-generated imagery (CGI) (digital or optics, animals or creatures) which look realistic, but would be dangerous, expensive, impractical, time-consuming or impossible to capture on film.

Prop tracking in film and television production (or filmmaking) can refer to a process of tracking a movement, position, and/or orientation of a physical prop within a video scene (e.g., film footage) so that digital assets can be accurately aligned with it in post-production. Props are currently being tracked using a marker-based tracking system. Marker-based tracking uses or requires placement of one or more markers on the prop-often high contrast spheres or cubes—at key points on the prop. The one or more markers can be simple geometric shapes or more complex patterns, depending on the marker-based tracking system.

During filming, one or more cameras capture the movement of these markers along with the action. In post-production, tracking software analyzes the footage frame by frame. The software is designed to recognize the markers and calculate marker positions and motions in three-dimensional (3D) space. This data is then used to create a “skeleton” or framework that matches the prop's movement. CGI elements can be attached to this skeleton, ensuring they move perfectly in sync with the filmed prop. The benefits of marker-based tracking include its accuracy and reliability. However, the downside is that the markers must often be removed from the final footage through a process called “painting out,” which is time-consuming.

### SUMMARY OF THE DISCLOSURE

Various details of the present disclosure are hereinafter summarized to provide a basic understanding. This summary is not an extensive overview of the disclosure and is neither intended to identify certain elements of the disclosure nor to delineate the scope thereof. Rather, the primary purpose of this summary is to present some concepts of the disclosure in a simplified form prior to the more detailed description that is presented hereinafter.

In an example, a computer implemented method can include receiving prop spatial data for a prop device in a physical space, receiving digital asset spatial data for a digital asset in a virtual space, updating the spatial data for the digital asset based on the prop spatial data, and updating a position, a movement, and/or an orientation of the digital asset in the virtual space based on the updated spatial data for the digital asset.

In another example, a method can include receiving prop spatial data for a prop device in a scene, receiving video data comprising video frames captured of the scene, generating a scene model of the scene with a digital asset, updating a position, orientation, and/or movement of the digital asset in the scene model based on the prop spatial data, compositing one or more video frames of the received video data and the digital asset with the updated position, movement, and/or orientation, and causing the composited video frames to rendered on output device.

In a further example, a computer implemented method can include identifying a video frame from video frames stored in a cache memory space based on video frame latency data. The video frame latency data can specify a number of video frames to be stored in the cache memory space before the video frame is selected. The method can further include identifying a scene related information frame of the scene related information frames based on a timecode of the video frame, and providing a composited video frame based on the video frame and the scene related information frame.

In a further example, a system for providing augmented video data can include memory to store machine-readable instructions and data, and one or more processors to access the memory and execute the machine-readable instructions. The machine-readable instructions can include a video frame retriever to identify a video frame from video frames based on video frame latency data. The video frame latency data can specify a number of video frames to be stored in the memory before the video frame is selected. The machine-readable instruction can further include a scene related frame retriever to identify a scene related information frame of scene related information frames based on a timecode of the video frame, a digital asset retriever to retrieve digital asset data characterizing a digital asset, and a digital compositor to provide the augmented video data with the digital asset based on the digital asset data, the scene related information frame, and the video frame.

In a further example, a computer implemented method can include identifying a video frame from video frames provided by a video camera representative of a scene during filming production based on video frame latency data. The video frame latency data can specify a number of video frames to be stored in memory of a computing platform before the video frame is selected. The method can further include identifying a scene related information frame of scene related information frames provided by scene capture devices based on an evaluation of a timecode of the video frame relative to a timestamp of the scene related information frames. The timestamp for the scene related information frames can be generated based on a frame delta value representative of an amount of time between each scene related information frame provided by a respective scene capture device of the scene capture devices. The method can further include providing augmented video data with a digital asset based on the scene related information frame and the video frame.

In an even further example, a computer-implemented method can include providing a scene model that is a virtual representation of a scene based on depth and color data captured for the scene, creating a miniaturized version of the scene model corresponding to a diorama of the scene, setting the virtual camera with respect to the scene model to provide a perspective view of the diorama, and causing the diorama of the scene to be outputted at the perspective view on an output device.

In another example, a computer-implemented method can include receiving waypoint instructions identifying virtual points for a digital asset for use a scene, updating a scene model to include the virtual points at locations in the scene model corresponding to locations in the scene to provide a waypoint scene model, providing augmented video data comprising one or more composited video frames with the virtual points in the scene based waypoint scene model, and causing the augmented video data to be rendered on an output device.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

Embodiments are described with reference to the accompanying drawings. In the drawings, like reference numbers can indicate identical or functionally similar elements. The drawing in which an element first appears is generally indicated by the left-most digit in the corresponding reference number.

FIG. 1 is a block diagram of a digital prop tracking system.

FIG. 2 is a block diagram of an example of a compositing engine (or system) that can be used for digital compositing during production (or filming).

FIG. 3 is a block diagram of an example of a computing platform.

FIG. 4 is a block diagram of an example of a system for visualizing video scenes with one or more digital assets.

FIG. 5 is a block diagram of an example of a waypoint system for animating a digital asset in a scene.

FIG. 6 is a block diagram of an example of a diorama pipeline for generating a diorama of a scene.

FIG. 7 is an example of a method for manipulating a digital asset through prop tracking.

FIG. 8 is an example of a method for providing augmented video data during production using digital asset prop tracking.

FIG. 9 is an example of a method for providing a composited video frame during production.

FIG. 10 is an example of a method for providing augmented video data during production.

FIG. 11 is an example of a method for waypoint animation of a digital asset in a scene.

FIG. 12 is an example of a method for outputting a diorama of a scene.

FIG. 13 is a block diagram of a computing environment that can be used to perform one or more methods according to an aspect of the present disclosure.

FIG. 14 is a block diagram of a cloud computing environment that can be used to perform one or more methods according to an aspect of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

One or more embodiments of the present disclosure relates to systems and methods that can be used during (or prior to) filming of a scene (also known as production) are disclosed herein. As video data and other related scene information (needed for digital compositing) arrives at a compositing device (also known as a compositor), in some instances, the compositor may not use most relevant scene data. This can introduce visual problems into composited video data provided by the compositor during filming. Because the compositor may receive data at different times (because different devices are used to provide the data over a network), in some instances, movements of a digital asset may not be properly synchronized with video footage. CGI synchronization issues can result in a number of visual problems that can make the CGI asset look unconvincing, or unrealistic during filming. Such visual problems can include, for example, unnatural movement, timing issues, lighting and shadow issues, and/or scale and perspective issues.

Visual problems can be problematic during on-set filming, for example, during complex VFX scenes as timing and choreography of actions need to be synchronized so that a director's vision or expectation can be met. Additionally, visual problems can also make it difficult to film, as it can be distracting, as well as propagate production errors downstream (e.g., to post production), requiring production teams to expedite resources to correct these errors. For example, if a particular VFX shot did not turn out as planned or there were mistakes in original footage, a VFX team would need to expend resources (e.g., computing processing resources) to identify the errors/mistakes and correct these issues post production.

Additionally, on-set filming is limited to viewing a scene or a film set through a traditional first or third person viewpoints. However, coordination of actors and/or digital assets (e.g., CGI assets) and scene assets (or objects) is difficult and complex as configurations of and/or interactions between objects, actors, and/or digital assets often involves an interplay of many different variables (e.g., object location, actor placement, actor actions, etc.). Traditional scene viewpoints are limited in scene visibility, which can cause the producer to miss errors that could be corrected during filming, further requiring that the post production team catch these mistakes. In some instances, a mistake can be so crucial that it may require reshooting of the scene. Examples are disclosed herein in which a data manager is used for digital compositing that can identify relevant scene related information data and modify timing of the scene related information data so that visual problems can be mitigated or eliminated in composited video data (or augmented video data), such as during on-set filming. By implementing the systems and methods herein, real-time (or near real-time (e.g., sub-second delay)) can be achieved at the outset (e.g., during pre-production). Because the systems and methods disclosed herein combine different filming techniques in combination with manage data timing of diverse data source devices (or systems) that communicate over a communication network enables (or allows) film makers or production (e.g., teams) to see filming results (with sub-second delay), and use those results to inform performance and capture.

In some examples, as disclosed herein, techniques are disclosed for providing a non-person viewpoint of a scene, for example, during filming, and, thus of a film set or a shooting location. According to one or more examples disclosed herein, a non-person viewpoint of a scene (that is a non first or third person viewpoint) can be provided (as a digital representation, referred to herein as a diorama) so that a producer (and/or other film personnel) can visualize a shot of the scene with digital asset information and make corrections in real-time (e.g., during filming). In some examples, as disclosed herein, techniques are described for waypoint animation. For example, virtual locations that define a virtual path can be rendered in the scene and can be used for navigating a digital asset throughout the scene. The virtual path in the scene enables the producer to visual movements of the digital asset before video shooting so that any scene errors can be corrected during production (rather than post-production).

While systems and methods are presented herein relating to production, the examples herein should not be construed and/or limited to only production. The systems and methods disclosed herein can be used in any application

One or more embodiments of the present disclosure also relate to digital prop tracking. Digital prop tracking can refer to a process of tracking a digital counterpart (a digital asset) within a three-dimensional (3D) space for a physical prop so that a position, a movement, and/or an orientation of the digital asset matches a physical prop's position, movement, and/or orientation. Thus, digital prop tracking involves tracking a physical object in a physical space (e.g., real-world environment, for example, a scene) and using the position, movement and/or orientation of the physical object to control or define the position, a movement, and/or an orientation of a digital asset in virtual space (e.g., 3D space). The position, movement and/or orientation of the physical object in the physical space can be referred to as object spatial data, whereas the position, a movement, and/or an orientation of the digital asset in the digital space can be referred to as digital asset spatial data. In some examples, digital prop tracking can include digital compositing. For example, the digital asset can be rendered in a shot of the scene (e.g., incorporated or integrated into video frames of the scene) based on the object spatial data. Thus, augmented video data can be generated with the digital asset having a position, movement, and/or orientation based on the object spatial data.

In some examples, the system and method as disclosed herein can be used during (or prior to) filming of a scene (also known as production). According to the examples disclosed herein, a prop can be tracked without the use of markers and thus marker-based systems, for example, during production. Through the use of the system and/or method as disclosed herein, a producer can in real-time (that is during production) can render (or cause) a digital asset to be inserted into the scene and animate the digital asset based on a location and/orientation of the prop. Using the system and/or method, as disclosed herein, the producer can visualize the scene with animated (or still digital assets) using compositing techniques (e.g., as disclosed herein) during production to see a movement and/or orientation of the digital asset relative to the scene (e.g., objects in the scene, for example, actors, physical objects, etc.). Thus, through the use of the system and/or method of the present disclosure reduces post-production costs as digital assets and/or props in the scene can be adjusted in real-time to minimize filming errors. The system and method disclosed herein can be used during production.

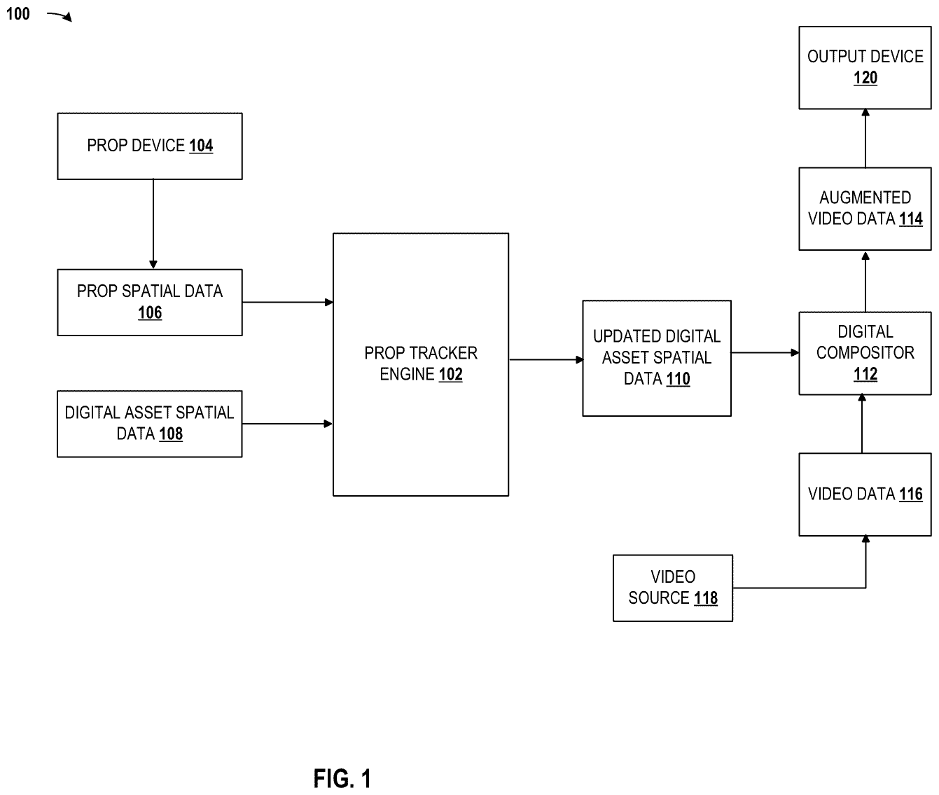

FIG. 1 is a block diagram of a digital prop tracking system 100, referred to herein as a “tracker system.” The tracker system 100 can be used for digital prop tracking, such as during film production, that is, filming of a scene. Thus, the tracker system 100 in some instances can be used during film production (e.g., not post production). While examples are presented herein in which the tracker system 100 is used for film production, the tracker system 100 can be used in other examples or applications. The tracker system 100 includes a prop tracker engine 102. The prop tracker engine 102 can be implemented as hardware, software, and/or a combination thereof. Thus, in some examples, the prop tracker engine 102 can be implemented as machine-readable instructions that can be executed on a computing platform or device, for example, as disclosed herein. The prop tracker engine 102 can be used to compute or determine digital asset spatial data for a digital asset that is to be rendered in a scene based on a position, movement and/or orientation of a prop device 104, which can be referred to as prop spatial data 106.

The prop device 104 can be any device that can provide its position, movement, and/or orientation. In some examples, the prop device 1204 can be any hardware, apparatus, or device that is designed with a specific purpose of providing prop spatial data, such as the prop spatial data 106. In some examples, the prop device 104 is a proprietary device that can provide the prop spatial data. In some examples, the prop device 104 is a mobile device, such as a tablet, or cellular device. Exemplary mobile devices can include, but not limited to, an iPhone®. In some examples, the prop device 104 includes an inertial measurement unit (IMU) or is an IMU.

The prop tracker engine 102 can receive the prop spatial data 106, as shown in FIG. 1. The prop tracker engine 102 can also receive digital asset spatial data 108, which can characterize a position, orientation, and/or movement of the digital asset in a 3D model of the scene. The 3D model of the scene, in some instances, can be rendered according to the examples as disclosed herein. In other examples, a different technique can be used for rendering the 3D model of the scene.

The prop tracker engine 102 can update (e.g., change, adjust, set, etc.) the initial position, orientation, and/or movement of the digital asset in the 3D model of the scene based on the prop spatial data 106. The prop tracker engine 102 can provide updated digital asset spatial data 110 based on the updating. Thus, the prop tracker engine 102 can update the digital asset to have an orientation based on the prop spatial data 106. During filming (production), the prop device 104 can provide the prop spatial data 106 and the prop tracker engine 102 can use that data to manipulate the digital asset in the 3D model of the scene (or 3D space). Thus, the prop device 104 can be manipulated (e.g., through moving it around) and the digital asset in the 3D model will follow the manipulation of the prop device 104. For example, if the prop device 104 is moved or caused to be moved, the digital asset in the 3D model will move as well based on a movement of the prop device 104.

In some examples, the tracker system 100 includes a digital compositor 112. The digital compositor 112 can provide augmented video data 114 based on the updated digital asset spatial data 110 and video data 116 that includes video frames of the scene. The video data 116 can be provided from a video source 118 (e.g., camera, a portable device (e.g., a mobile phone, a tablet, etc.)). The video source 118 can be used to capture the scene. The digital compositor 112 can insert the digital asset into one or more video frames of the video frames of the scene of the video data 116 to compose augmented video frames corresponding to the augmented video data 114. The augmented video data 114 can be rendered or caused to be rendered on an output device 120 (e.g., a display, heads-up display, a portable device (e.g., a tablet, a mobile phone, etc.), a viewing screen, a television, etc.). In some examples, the video source 118 includes the output device 120.

Accordingly, the tracker system 100 can be used for digital prop tracking through use of the prop device 104 and the prop tracker engine 102 eliminating the need for marker-based systems and allowing for improved film production (e.g., by minimizing errors) while minimizing post-production costs.

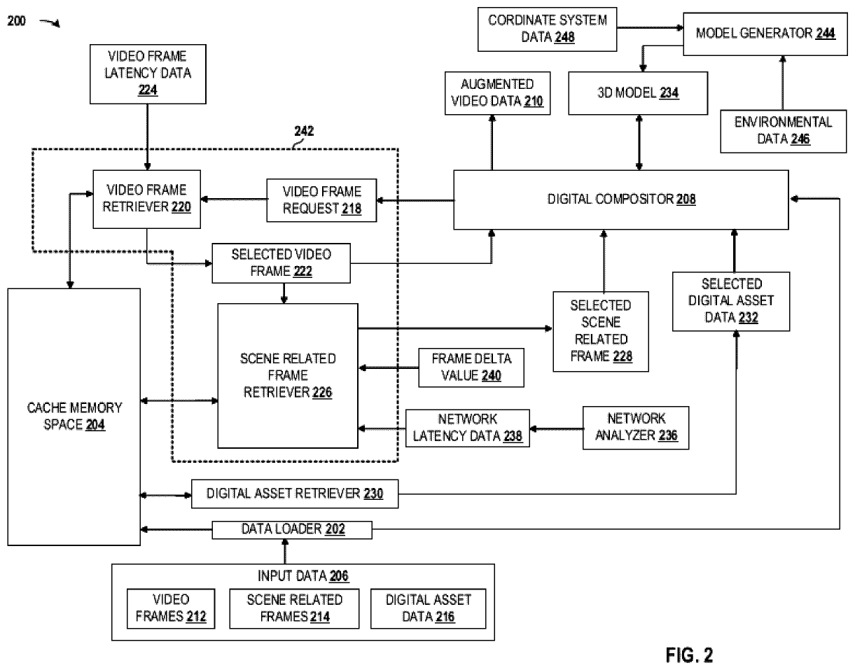

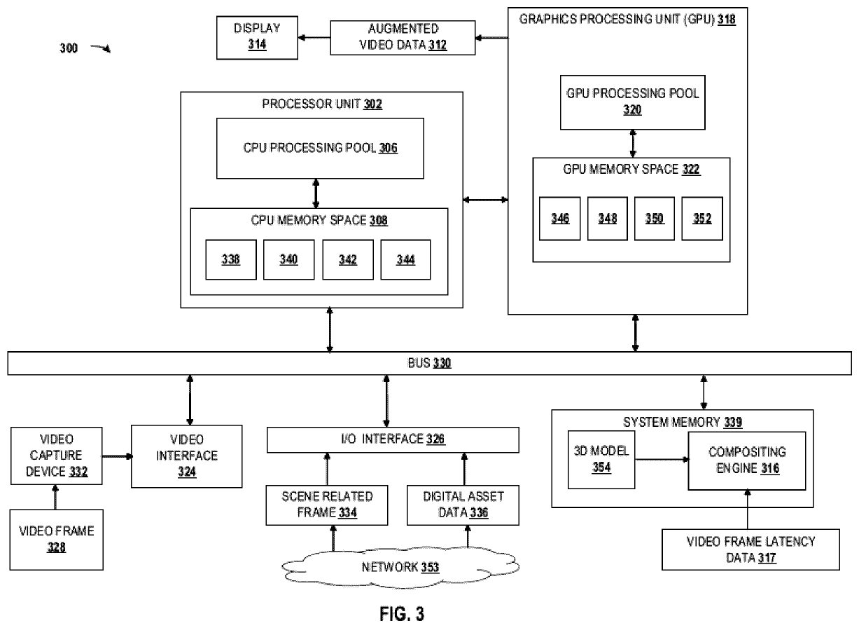

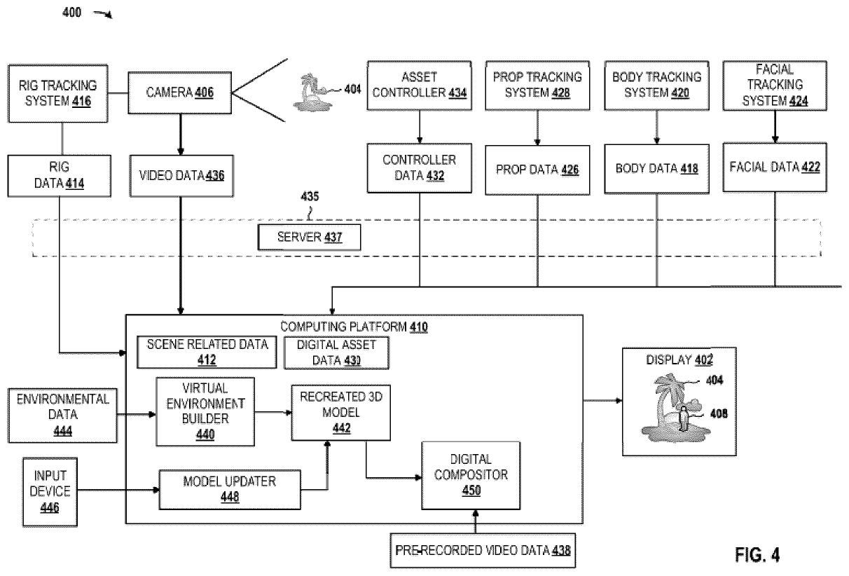

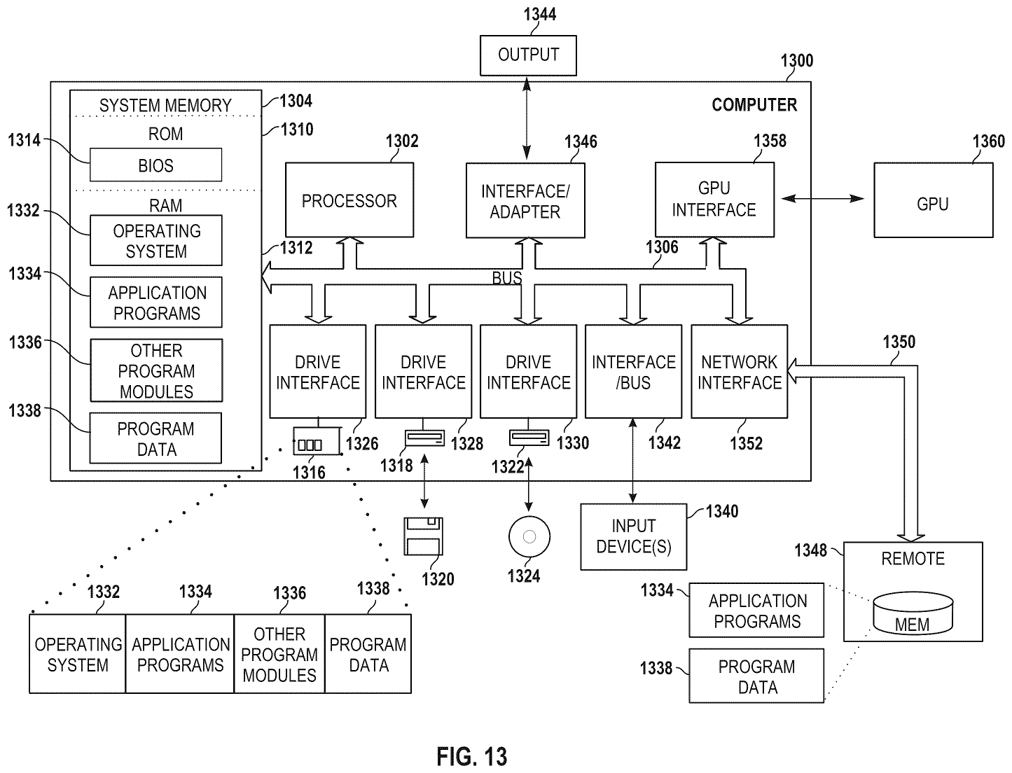

FIG. 2 is a block diagram of an example of a compositing engine 200 that can be used for digital compositing during production. The compositing engine 200 can be executed on a computing device, such as a computing platform (e.g., a computing platform 300, as shown in FIG. 3, or a computing platform 410, as shown in FIG. 4), or on a computing system (e.g., a computing system 1300, as shown in FIG. 13). The compositing engine 200 can include a data loader 202 to load input data 206 into the system 200. The data manager 242 can partition a cache memory space 204 for storage of input data 206 corresponding to data that is to be used by a digital compositor 208 of the compositing engine 200 for generating augmented video data 210. In some examples, the digital compositor 208 is the digital compositor 112, as shown in FIG. 1. Thus, reference can be made to one or more examples of FIG. 1 in the example of FIG. 2. For example, the data manager 242 (or the data loader 202) can partition the cache memory space 204 into a number of cache locations (or partitions) for storing video frames 212, scene related information frames 214, and digital asset data 216 for the scene. In some examples, the video frames 212 can be provided as part of the video data 116, as shown in FIG. 1. Thus, in some examples, the video source 118, as shown in FIG. 1, can provide the video frames 212.

The data manager 242 (or the data loader 202) can store the video frames 212 in a first set of partitions of the partitions of the cache memory space 204, the scene related information frames 214 in a second set of partitions of the cache memory space 204, and the digital asset data 216 in a third set of partitions of the cache memory space 204. In some examples, the first set of partitions can include even and odd video frame cache locations, and each video frame of the video frames 212 can be stored in one of the even and odd video frame cache locations based on respective frame numbers of the video frames. In some examples, the video frames 212 are provided during production, such as from a video camera (e.g., a digital video camera), and thus in real-time as the scene is being shot. In other examples, the video frames 212 are provided from a storage device, for example, during post-production. Thus, in some instances, the compositing engine 200 can be used during post-production to provide the augmented video data 210. In some examples, the augmented video data 210 is the augmented video data 114, as shown in FIG. 1.

The scene related information frames 214 can be provided over a network from different types of scene capture devices used for capturing information relevant to a filming of the scene being captured by a video camera. The video frames 212 are provided by the video camera. The network can be a wired and/or wireless network. Each scene related information frame of the scene related information frames 214 can include a timestamp generated based on a local clock of the respective scene capture device. The video frames can be provided by the video camera at a different frequency than the scene related information frames 214 are being provided by the scene capture devices.

The term “frame” as used herein can represent or refer to a discrete unit of data. Thus, in some examples, the term frame as used herein can refer to a video frame (e.g., one or more still images that have been captured or generated by the video camera), or a data frame (e.g., a pose data frame). By way of example, a respective scene related information frame of the scene related information frames 214 can include camera pose data for the video camera that provides the video frames 212. Pose data for a video camera typically refers to the position and orientation of the camera at a particular moment in time, expressed in a three-dimensional (3D) space. It typically includes information such as the camera's location, orientation, and field of view, as well as other relevant parameters such as focal length, aperture, and shutter speed. In some examples, when the cache memory space 204 has been partitioned, the digital compositor 208 can initiate digital compositing, which can include applying VFX to at least one video frame (e.g., inserting a CGI asset). In some examples, the digital compositor 208 can include or communicate with the prop tracker engine 102, as shown in FIG. 1. The prop tracker engine 102 can be used to provide spatial data (e.g., a position, an orientation, and/or movement) for a digital asset to be composited by the digital compositor 208 to provide the augmented video data 210.

For example, the digital compositor 208 can issue a video frame request 218 for a video frame of the video frames 212. The compositing engine 200 includes a data manager 242 that includes a video frame retriever 220, which can process the video frame request 218 to provide a selected video frame 222. The video frame retriever 220 can provide the selected video frame 222 based on video frame latency data 224. The video frame latency data 224 can specify a number of video frames to be stored in the cache memory space 204 for digital compositing so that minimal or no visual problems (e.g., as described herein) are present in the augmented video data 210. Thus, the video frame latency data 224 can specify how fast composited video frames (that are part of the augmented video data 210) are rendered on a display. For example, if the video frame latency data 224 indicates a three (3) frame latency, the video frame retriever 220 can provide the third stored frame as the selected video frame 222 to the digital compositor 208.

The selected video frame 222 can also be provided to a scene related frame retriever 226 of the data manager 242. The scene related frame retriever 226 can extract a timecode from the selected video frame 222. Using the timecode, the scene related frame retriever 226 can identify a scene related information frame of the scene related information frames 214. In some examples, the scene related information frame is identified by evaluating the extracted timecode to timestamps of the scene related information frames 214 and selecting the scene related information frame that is closest in time or distance to the timecode of the selected video frame 222. Other techniques for identifying the scene related information frame of the scene related information frames 214 can also be used, for example, as disclosed herein. The scene related frame retriever 226 can provide the scene related information frame as a selected scene related information frame 228, as shown in FIG. 1, which can be received by the digital compositor 208. The compositing engine 200 also includes a digital asset retriever 230, which can retrieve relevant digital asset data for the scene stored in the cache memory space 204 and provide this data to the digital compositor 208 as selected digital asset data 232. In some examples, the data manager 242 includes the digital asset retriever 230.

In some examples, the digital compositor 208 can receive a virtual environment of the scene to provide a 3D model 234 of the scene. The 3D model 234 can be used by the digital compositor 208 for generating the augmented video data 210. In some examples, the 3D model 234 can be generated by a model generator 244 based on environmental data 246. The environmental data 246 can be provided by one or more environmental sensors (not shown in FIG. 2). The one or more environmental sensors can include, for example, infrared systems, light detection and ranging (LIDAR) systems, thermal imaging systems, ultrasound systems, stereoscopic systems, RGB camera, optical systems or any device/sensor system currently known in the art, and combinations thereof, that are able to measure/capture depth and distance data of objects in an environment. Thus, the environmental data 246 can characterize depth and distance data of objects in an environment (e.g., the scene).

In some examples, QR codes (or other image indicia) can be used to establish a common origin in a coordinate system of the actual environment (e.g., the scene). A number of QR codes can be used to define an origin location for the coordinate system for the actual environment. The QR codes can have different orientations to improve X, Y, Z information of the coordinate system. Information characterizing the coordinate system and the common origin can be provided as coordinate system data 248. For example, a device (e.g., a portable device, such as mobile phone, tablet, etc.) can be used to record each location/position/orientation of each QR code in the coordinate system of the actual environment and provide this data as the coordinate system data 248. The model generator 244 can receive the coordinate system data 248 and register virtual markers in the 3D model 234 as a starting location for digital assets to be inserted into the 3D model 234. Thus, the model generator 244 can insert the digital asset into the 3D model 234 at the virtual marker registered in the 3D model 234. In some examples, a graphical indication is provided in the 3D model 234 indicating where the digital asset is to be placed in the 3D model 234. Accordingly, the coordinate system data 248 can provide a translation (or registration) for digital assets into the actual environment.

The 3D model 234 can include a virtual camera representative of the video camera being used for filming the scene and a digital asset (e.g., a CGI asset) for insertion into the scene. The digital compositor 208 can output composited video frames that can be provided as the augmented video data 210 based on the 3D model 234 and selected video frames and scene related information frames, and, in some instances, the digital asset data provided from the cache memory space 204. Thus, a respective composited video frame can be provided based on the selected video frame 222, the selected scene related information frame 228, and in some instances based on the selected digital asset data 232.

In some examples, the 3D model 234 can be updated by the digital compositor 208 based on the selected scene related information frame 228. For example, the digital compositor 208 can update a pose of the virtual camera in the 3D model 234 based on nearest pose data captured or measured for the video camera (reflected as the selected scene related information frame 228). By way of further example, if a video camera's position changed in a real-world environment to a new camera position (from a prior camera position), the 3D model 234 can be updated to reflect the video cameras new position and the position of any CGI assets in the 3D model 234 can be updated to match the new video camera position based on the selected scene related information frame 228.

The digital compositor 208 can adjust for example, the position, orientation, and/or scale of the CGI asset in the 3D model 234 so that the CGI asset appears in a correct location in the 3D model 234 relative to a real-world footage (e.g., the real-world environment). The digital compositor 208 can use the updated 3D model for providing the augmented video data 210. For example, the digital compositor 208 can layer the CGI asset on top of the selected video frame so that the CGI asset appears in the scene at an updated position based on the updated 3D model 234 to provide the composited video frame.

Because the scene related information frames 214 are provided over the network (e.g., LAN, WAN, and/or the Internet), the scene related information frames 214 can experience network latency. To compensate for network latency effects on the scene related information frames 214, the compositing engine 200 can include a network analyzer 236. The network analyzer 236 can analyze the network (e.g., a network 253, as shown in FIG. 2, or a network 435, as shown in FIG. 4) over which the scene capture devices provide the scene related information frames 214 to determine a network latency of the network. In some examples, the data manager 242 includes the network analyzer 236. The network analyzer 236 can output network latency data 238 characterizing the network latency of the network, which can be received by the scene related frame retriever 226. The scene related frame retriever 226 can update a respective timestamp of the scene related information frames 214 based on the network latency of the network over which the scene related information frames 214 are provided based on the network latency data 238. Thus, in some examples, the scene related information frame being identified by the scene related frame retriever 226 can be based on an evaluation of adjusted timestamps (for network latency) of the scene related information frames 214 and the timecode of the video frame.

In additional or alternative examples, the respective timestamp of the scene related information frames 214 can be updated based on a frame delta value 240. The frame delta value 240 can be representative of an amount of time between each scene related information frame provided by a respective scene capture device of the scene capture devices. Because an internal clock of the respective scene capture device is internally consistent, the delta value between timestamps of neighboring scene related information frames from the same scene capture device can be about the same for a period of time. Using the frame delta value, the scene related frame retriever 226 can adjust the timestamp of the scene related information frame provided by the respective scene capture device to compensate for clock drift of the respective scene capture device.

By configuring the compositing engine 200 based on the video frame latency data 224, and in some instances, further based on the network latency data 238 and/or the frame delta value 240, the compositing engine 200 can provide an augmented shot of a scene at a given frame of latency (e.g., three (3) frame of latency) that is sufficient so that shots of the scene can be visualized during production with little to no visual problems. This is because the compositing engine 200 uses the data manager 242 to identify relevant scene related information frames and modify a timing of these frames according to a timestamp adjusting schema (as disclosed herein) to allow for accurate alignment of non-frame data from various and dissimilar scene sources (e.g., scene capture devices) with a video frame.

FIG. 3 is a block diagram of an example of a computing platform 300 that can be used for digital compositing. The computing platform 300 as described herein can composite video frames and digital assets to provide a composited stream of video frames for rendering on a display. The computing platform 300 can include a processor unit 302. The processor unit 302 can be implemented on a single integrated circuit (IC) (e.g., die), or using a number of ICs. The processor unit 302 can be a general-purpose processor, a special-purpose processor, an application specific processor, an embedded processor, or the like. The processor unit 302 can include an N number of processors, which can be collectively referred to as a CPU processing pool 306 in the example of FIG. 3. In some instances, each of the processors can include a number of cores.

The processor unit 302 can include cache memory that can be referred to collectively as a CPU memory space 308 in the example of FIG. 3. The cache memory can include, for example, L1, L2, and/or L3 cache. The CPU memory space 308 can be a logical representation of the cache memory of the processor unit 302, which can be partitioned according to the examples disclosed herein. In some examples, the CPU memory space 308 is distributed across multiple dies. For clarity and brevity purposes not all components (e.g., functional blocks, such as a memory controller, a system interface, an Input/Output (I/O) device controller, a control unit, an arithmetic logic unit (ALU), etc.) of the processor unit 302 are shown in the example of FIG. 3.

In some instances, the CPU memory space 308 includes a respective cache (or a subset of caches) for each of the processors (or the cores of the processors). In further examples, the CPU memory space 308 can include shared cache (e.g., L3 cache) that can be shared among processors and/or the cores. The CPU memory space 308 can be partitioned by a compositing engine 316 for real-time generation of augmented video data 312. The compositing engine 316 can correspond to the compositing engine 200, as shown in FIG. 2. In some examples, the compositing engine 316 can include or communicate with the prop tracker engine 102, as shown in FIG. 1. Thus, reference can be made to one or more examples of FIGS. 1-2 in the example of FIG. 3. The prop tracker engine 102 can be used to provide spatial data (e.g., a position, an orientation, and/or movement) for a digital asset to be composited by the compositing engine 316 to provide the augmented video data 312. In some examples, the augmented video data 312 corresponds to the augmented video data 114, as shown in FIG. 1, or the augmented video data 210, as shown in FIG. 2. The augmented video data 312 can include one or more composited video frames that can be rendered on a display 314.

In some instances, real-time generation of the augmented video data 312 can correspond to generation of video frames at less than or equal to three (3) frames of latency. One or more processors of the processors of the CPU processing pool 306 can read and execute program instructions (or parts thereof) representative of a compositing engine 316. The compositing engine 316 can be executed on the processor unit 302 to implement at least some of the functions, as disclosed herein. In some examples, the compositing engine 316 is representative of an application (e.g., a software application) that can be executed on the computing platform 300.

The computing platform 300 can include a graphics processing unit (GPU) 318 for providing the augmented video data 312. For example, the GPU 318 can include a GPU processing pool 320 that can provide composited data that can be converted to provide the augmented video data 312. For example, the GPU processing pool 320 can include a number of processing units. The GPU 318 can include a GPU memory space 322. For example, the GPU memory space 322 can include similar and/or different types of memory, for example, local memory, shared memory, global memory (e.g., DRAM), texture memory, and/or constant memory. Thus, the GPU memory space 322 can include cache memory, such as L2 cache. For clarity and brevity purposes not all components (e.g., interconnections, I/O interfaces, registers, ALU's, texture units, load/store units, other fixed function blocks, etc.) of the GPU 318 are shown in the example of FIG. 3. As the CPU memory space 308, the GPU memory space 322 can be a logical representation of the cache memory of the GPU 318 that can be partitioned according to the examples disclosed herein. In some examples, the CPU memory space 308 and/or the GPU memory space 322 can correspond to the cache memory space 204, as shown in FIG. 2.

For example, the computing platform 300 can include a number of interfaces, such as a video interface 324 and an I/O interface 326. The video interface 324 can be used to receive a video frame 328, which can be provided over a bus 330 to the GPU 318. In some examples, the video frame 328 is provided by a video capture device 332, as shown in FIG. 1. The video frame 328 can be representative of an image of a scene. The video frame 328 can also include metadata, such as a timecode (or timestamp), frame rates, resolution, and/or other information describing the video frame 328 itself.

In some examples, the video capture device 332 is implemented as a video capture card, and thus can be implemented as part of the computing platform 300. In other instances, the video capture device 332 is implemented as a stand-alone device that can communicate (e.g., using a wired and/or wireless medium) with the computing platform 300. The video capture device 332 can receive video data (e.g., a video data 436, as shown in FIG. 4) from a video camera (e.g., a video camera 406, or from another video source (e.g., storing recorded video data, for example in a cloud, on a disk, or another storage location)). In some examples, the video camera is a digital video camera, such as a digital motion picture camera (e.g., Arri Alexa developed by Arri). In other examples, the video camera can correspond to a camera of a portable device (e.g., a mobile phone, a tablet, etc.). In some examples, the video frame 328 can correspond to one of the video frames 212, as shown in FIG. 2.

In some examples, the I/O interface 326 can be used to receive scene related information frame 334 and digital asset data 336. The scene related information frame 334 can include, for example, face tracking data, body tracking data, asset pose data, and/or camera pose data. In some examples, the scene related information frame 334 can correspond to one of the scene related information frames 214, as shown in FIG. 2. The type of scene related information frame 334 can depend on a type of scene capture device used for the scene. For example, the I/O interface 326 can include a network interface, which can be used to communicate with external devices, systems, and/or servers to receive the scene related information frame 334 and the digital asset data 336. The scene related information frame 334 and/or the digital asset data 336 can be provided over a network 353, as shown in FIG. 3.

The network 353 can include one or more networks and/or the Internet. The one or more networks can include for example a local area network (LAN) or a wide area network (WAN). In additional or alternative examples, the I/O interface 326 can include a hard disk drive interface, a magnetic disk drive interface, and an optical drive interface, or an input device interface, which can be used to allow for the scene related information frame 334 and the digital asset data 336 to be loaded (e.g., stored) into a system memory 339. The system memory 339 can be representative of one or more memory devices, such as random access memory (RAM) devices, which can include static and/or dynamic RAM devices. The one or more memory devices can include, for example, a double data rate 2 (DDR2) device, a double data rate 3 (DDR3) device, a double data rate 4 (DDR4) device, a low power DDR3 (LPDDR3) device, a low power DDR4 (LPDDR4) device, a Wide I/O 2 (WIO2) device, a high bandwidth memory (HBM) dynamic random-access memory (DRAM) device, HBM 2 DRAM (HBM2 DRAM) device a double data rate 5 (DDR5) device, and a low power DDR5 (LPDDR5) device (e.g., mobile DDR). In some examples, the one or more memory devices can include DDR SDRAM type of devices.

The processor unit 302, the GPU 318, the video interface 324, the I/O interface 326, and the memory 339 can be coupled to the system bus 330. The system bus 330 can be representative of a communication/transmission medium over which data can be provided between the components, as shown in FIG. 3. In some instances, the system bus 330 includes any number of buses, for example, a backside bus, a frontside (system) bus, a peripheral component interconnect (PCI) or PCIe bus, etc. The system bus 330 can include corresponding circuit and/or devices to enable the components to communicate and exchange data for providing the augmented video data 312 based on the video frame 328, the scene related information frame 334, and the digital asset data 336.

In some examples, the processor unit 302 and/or the GPU 318 can convert the video frame 328 to a texture file depending on an implementation and design of the computing platform 300. For example, the video frame 328 can be decoded and decompressed (e.g., by the processor unit 302 or the GPU 318), and then converted into a texture file format that can be loaded and rendered by the GPU 318 with VFX according to the examples disclosed herein. In examples wherein the processor unit 302 has sufficient computational power, the processor unit 302 can implement video frame to texture file conversion, and the GPU 318 can use a texture file for the video frame 328 for image rendering. In some examples, the conversion of the video frame to a texture file is performed by both the processor unit 302 and the GPU 318, with each handling different operations of a conversion process. For example, the processor unit 302 can be responsible for decoding and decompressing the video frame 328, while the GPU 318 can be responsible for converting a decoded video frame into the texture file format and image rendering.

Overall, the specific implementation of the video frame to texture file conversion process can depend on system architecture, hardware capabilities, and software design of the computing platform 300. The compositing engine 316 can be used to control components of the computing platform 300 to implement digital compositing to provide a composited video frame based on the video frame 328, the scene related information frame 334 and the digital asset data 336. For example, the compositing engine 316 can be implemented as machine-readable instructions that can be executed by the CPU processing pool 306 to control a timing of when data is provided to and/or from the GPU 318, and/or loaded/retrieved from the CPU and/or the GPU memory spaces 308 and 322, and processed.

During CGI filming, it is desirable to know a location and/or behavior (movements) of a CGI asset and other elements relative to each other in the scene. That is, during production, a director or producer may want to know the position and/or location of the CGI asset so that other elements (e.g., actors, props, etc.), or the CGI asset itself, can be adjusted to create a seamless integration of the two. For example, the director may want the CGI asset to move and behave in a way that is consistent with live-action footage. Knowledge of where the CGI asset is to be located and how the CGI asset will behave is important for the director during filming (e.g., production) as it can minimize retakes, as well as reduce post-production time and costs. For example, knowledge of how the CGI asset is to behave in the scene can help the director adjust a position or behavior of an actor relative to the CGI asset. Generally, to help actors know where to look and how to interact with the CGI asset, filmmakers often use visual cues on set, such as reference objects, markers, targets, verbal cues, and in some instances, show the actor a pre-visualization of the scene. Pre-visualization (or “pre-viz”), is a technique, used in filmmaking to create a rough, animated version of a final sequence that gives the actor a rough idea of what the CGI asset will look like, where it will be positioned, and how it will behave before the scene filmed.

Alternative pre-visualization techniques have been developed that enable the director to view the asset in real-time on a display, during filming. For example, the director can use a previsualization system that has been configured to provide a composited video feed with an embedded CGI asset therein while the scene is being filmed. One example of such a device/system is described in U.S. patent application Ser. No. 17/410,479, and entitled “Previsualization Devices and Systems for the Film Industry,” filed Aug. 24, 2021, issued as U.S. Pat. No. 11,682,175, which is incorporated herein by reference in its entirety. The previsualization system allows the director to have a “good enough” shot of the scene with the CGI asset so that production issues (e.g., where the actor should actually be looking, where the CGI asset should be located, how the CGI asset should behave, etc.) can be corrected during filming and thus at a production stage. The previsualization system can implement digital compositing to provide composited video frames with the CGI asset embedded therein.

During digital compositing, movements of the CGI asset are synchronized with video footage in a film or video so that when the composited video frames are played back on a display the movements of the CGI asset are coordinated with movements of the live-action footage. Previsualization systems can be configured to provide for CGI asset-live-action footage synchronization. For example, the previsualization system can implement composition techniques/operations to combine different elements, such as live-action footage, the CGI asset, CGI asset movements, other special effects, into augmented video data (one or more composited video frames). The augmented video data can be rendered on the display and visualized by a user (e.g., the director).

In some instances, data for generating the augmented video data may arrive at different times at a compositing device (also known as a compositor) of the previsualization system, for example, during filming. The data can arrive at different times over a network (such as the network 353, as shown in FIG. 3) at the compositing device. Additionally, the data can be generated by different scene capture devices based on an internal or local clock, which can drift over time. Additionally, in some instances, the scene capture devices may not be not time-synced (or jammed) (e.g., connected to a central timecode generator) with the video camera. In some scenarios, one or more scene capture devices may not support jamming. Thus, as video frame and other scene data arrives at the compositor, the compositor may not use the most relevant scene related information data (frame) for digital compositing, which can introduce visual problems into the composited video data. Because the compositor may receive the data at different times, in some instances, movements of the CGI asset are not properly synchronized with the video footage, which can result in a number of visual problems that can make the CGI asset look unconvincing, or unrealistic during filming.

According to the examples disclosed herein, the compositing engine 316 can be configured to mitigate or eliminate (in some instances) visual problems in the augmented video data 312. The compositing engine 316 can control which scene related information frame 334 is used for compositing to provide the augmented video data 312 having reduced or no visual problems. Thus, in some examples, the compositing engine can employ the data manager 242, as shown in FIG. 2.

For example, during filming (production), for digital compositing, the video camera can provide the video frame 328 to the computing platform 300 that the video interface 324 can communicate over the bus 330 to the GPU 318. In some examples, the video frame 328 is loaded into the CPU memory space 308 and/or the GPU memory space 322 for VFX processing (e.g., CGI insertion, etc.). In an example, the CPU memory space 308 can include even and odd video frame cache locations 338-340, a scene cache location 342, and a digital asset cache location 344.

The processor unit 302 or the GPU 318 can load the video frame 328 into one of the even or odd video frame cache locations 338-340 based on the timecode of the video frame 328. For example, if the timecode for the video frame in the video frame 328 appears as 01:23:45:12, the processor unit 302 or the GPU 318 can load the video frame 328 into the even video frame cache location 338 because “12” is an even number. A timecode for a video frame is a numerical representation of a specific time at which a frame appears in a video, and includes hours, minutes, seconds, and frames. The video frame 328 loaded into the even video frame cache location can be referred to as even video frame and thus a video frame loaded into the odd video frame cache location can be referred to as an odd video frame.

In some examples, the GPU 318 (or in combination with the processor unit 302) can convert the video frame 328 to a texture file format, which can be referred to as texture frame data. The texture frame data can be stored in the GPU memory space 322. For example, the compositing engine 316 can cause the GPU processing pool 320 (or in combination with the CPU processing pool 306) to convert the video frame 328 to provide the texture frame data. The compositing engine 316 can cause threads to be assigned to processing elements of the GPU 318 and/or the processor unit 302 for conversion of the video frame 328. Once converted, the texture frame data can be stored in the even video frame cache location 338 (based on the timecode for the video frame 328), and can be referred to as even texture frame data.

A subsequent received video frame can be processed in a same or similar manner as disclosed herein and stored in the odd video frame cache location 340 rather than the even video frame cache location 338. In some examples, once the subsequent video frame is converted to a texture frame data, the texture frame data can be stored in the odd video frame cache location 340 (based on the timecode for the subsequent video frame), and can be referred to as odd texture frame data. For example, if the timecode for the subsequent video frame is “13” the processor unit 302 or the GPU 318 can load the subsequent video frame (or the odd texture frame data) into the odd video frame cache location 340 because “13” is an odd number.

In some instances, the compositing engine 316 can receive video frame latency data 317. The video frame latency data 317 can specify a number of video frames to be stored in the CPU or GPU memory space 308 or 322 for digital compositing (prior to digital compositing) so that minimal or no visual problems are present in the augmented video data 312. Thus, the video frame latency data 317 can specify how fast composited video frames are rendered on the display 314. Accordingly, the number of frames specified by the video frame latency data 317 can be such that little to no visual problems are present in the augmented video data 312. By way of non-limiting example, the video frame latency data 317 indicates three (3) video frames. The compositing engine 316 can select or identify a video frame (or texture frame data) for digital compositing based on the video frame latency data 317. For example, if the video frame latency data 317 indicates three video frames, the compositing engine 316 can select the third video frame (stored in a memory space) for digital compositing.

A time or amount of time that it takes to generate the texture frame data can change from video frame to video frame due to processing or loading requirements of the computing platform 300. An amount of processing required can change based on frame complexity (e.g., with more complex visual content). Thus, video frame conversion time (the amount of time to generate the texture frame data) can vary or change from video frame to video frame. Additionally, the odd and even video frames (or odd and even texture frame data) can be loaded into corresponding cache memory space locations (for further processing) before the scene related information frame 334 arrives at the computing platform 300. In some examples, by the time the third video frame arrives and is stored (in some instances converted to a corresponding texture file and then stored), the scene related information frame 334 (generated at about the time that the video frame 328 was generated) has arrived at the computing platform 300. Because the compositing engine 316 selects, for example, the third video frame for digital compositing, this provides sufficient time for the arrival of the scene related information frame 334 at the computing platform 300.

In some examples, the compositing engine 316 can partition the GPU memory space 322. For example, if the GPU 318 has sufficient computational power, the GPU memory space 322 can be partitioned in a same or similar manner as the CPU memory space 308. Thus, in some examples, the GPU memory space 322 can include even and odd video frame cache locations 346-348, a scene cache location 350, and a digital asset cache location 352. Video frames (or corresponding texture frame data) can be stored in the even and odd video frame cache locations 346-348 in a same or similar manner as disclosed herein. Thus, in some implementations, the even/odd video frame writes (or corresponding texture files, if converted by the GPU processing pool 320) can be eliminated and video frame (or texture file) data can be stored in the GPU memory space 322 instead. In examples wherein corresponding video frame needs to be saved on an external device, the GPU 318 can store the corresponding video frame at the CPU memory space 308 so that the corresponding video frame can be provided to the external device.

Once the scene related information frame 334 is received, the compositing engine 316 can cause the scene related information frame 334 to be stored in the memory 339 (for later retrieval), the scene cache location 342, or the scene cache location 350. Continuing with the example of FIG. 3, the compositing engine 316 can cause the processor unit 302 or the GPU 318 to select the third video frame (or third texture frame data) from the CPU memory space 308 or the GPU memory space 322 in response to receiving the scene related information frame 334. The compositing engine 316 can cause the scene related information frame 334 to be loaded into one of the scene cache location 342 or the scene cache location 350. The compositing engine 316 can also cause the digital asset data 336 to be loaded into one of the digital asset cache location 344 or the digital asset cache location 352 for digital compositing.

In some examples, the compositing engine 316 can cause the processor unit 302 or the GPU 318 to generate a virtual environment (a 3D model) 354 that can be representative of the scene, and thus a real-world environment. The compositing engine 316 (or another system) can insert a CGI asset into the 3D model 354 based on the digital asset data 336. In other examples, a different system can be used to create the virtual environment, which can be provided to the computing platform 300. The process of creating the 3D model 354 can include for example creating objects and elements in the scene, such as buildings, props, characters, special effects, etc. The 3D model 354 can include a virtual camera that can correspond to the video camera being used to capture the scene. The virtual camera can be adjusted based on camera pose data. Because the location of the CGI asset is known in the 3D model 354 and the virtual environment is representative of the scene, the CGI asset can be inserted into the scene during digital compositing based on the digital asset data 336. In some examples, the 3D model 354 corresponds to the 3D model 234, as shown in FIG. 2.

In some examples, a scene capture device providing the scene related information frame 334 can record or measure relevant data at a different frame rate than the video camera provides video frames. For example, the scene capture device can provide scene related information frames at higher frame rate (e.g., at about 60 FPS) than the digital camera (e.g., at about 30 FPS). Because the scene capture device provides the scene related information frame 334 at a different frequency than the video camera provides the video frame 328, use of incorrect scene related information can introduce visual problems into the augmented video data 312. According to the examples disclosed herein, the compositing engine 316 can identify the most appropriate or correct scene related information frame for digital compositing (e.g., by the digital compositor 208, as shown in FIG. 2). The scene related information frame 334 provided at each instance by a corresponding scene capture device can include a timestamp, which can indicate an instance in time (based on a local clock of the scene capture device) that the scene related information frame 334 was generated.

For example, the compositing engine 316 can cause the processor unit 302 or the GPU 318 to update the 3D model 354 based on the scene related information frame 334. The compositing engine 316 causes the processor unit 302 or the GPU 318 to evaluate the scene related information frame 334 provided at different time instances by the corresponding scene capture device to identify the scene related information frame 334 with a timestamp that is closest to the timecode of a selected video frame (e.g., the third video frame). In some examples, the compositing engine 316 can cause the processor unit 302 or the GPU 318 to convert the timecode for the selected video frame to a timestamp. For example, the compositing engine 316 can cause the processor unit 302 or the GPU 318 to convert the time code based on a frame rate of the video camera, and a frame number of the selected video frame. As an example, if a timecode for the 14th frame of a video is being provided at a frame rate of 30 FPS (by the video camera), the calculation would be: timestamp=(14-1)/30=0.367 seconds. Using the calculated timestamp for the selected video frame, the compositing engine 316 can cause the processor unit 302 or the GPU 318 to identify the scene related information frame 334 with the timestamp that is closest to the timestamp of the selected video frame, which can be referred to as a nearest scene related information frame.

The compositing engine 316 can cause the processor unit 302 or the GPU 318 to update the 3D model 354 based on the nearest scene related information frame. For example, the compositing engine 316 can cause the processor unit 302 or the GPU 318 to update a pose of the virtual camera in the 3D model 354 based on nearest pose data captured or measured for the video camera. As each instance of the scene related information frame 334 arrives at the computing platform 300, the scene related information frame 334 can be stored in the memory 339, or in a corresponding cache memory space (e.g., one of the CPU or GPU memory spaces 308 and 322).

The compositing engine 316 can cause the processor unit 302 or the GPU 318 to identify the nearest scene related information frame for generating of the composited video frame. By way of example, if the video camera's position changed in the real-world environment to a new camera position (from a prior camera position), the 3D model 354 can be updated to reflect the video cameras new position and the position of any CGI assets in the 3D model 354 can be updated to match the new video camera position based on the nearest scene related information frame. The compositing engine 316 can cause the processor unit 302 or the GPU 318 to adjust for example, the position, orientation, and/or scale of the CGI asset in the 3D model 354 so that the CGI asset appears in a correct location in the 3D model 354 relative to a real-world footage (e.g., the real-world environment).

For example, if the timestamp for the selected video frame (or selected texture frame data) is closer (e.g., in distance, time, percentage, etc.) to a first timestamp value of a first scene related information frame than a second timestamp value of a second scene information related frame, the compositing engine 316 can use the scene related information frame 334 (e.g., one of the first or second scene related information frame) with the given timestamp value as the nearest scene related information frame. In some examples, the compositing engine 316 can cause the processor unit 302 or the GPU 318 to use interpolated scene related data for updating the 3D model 354. For example, if the timestamp for the selected video frame is a given distance, time value, or percentage, from the first and second timestamp values, the compositing engine 316 can cause the processor unit 302 or the GPU 318 to interpolate the scene related data based on the first and second scene related datasets. The interpolated scene related data can be used as the nearest scene related information frame for updating the 3D model 354.

The processor unit 302 or the GPU 318 can use the updated 3D model for digital compositing. In some examples, the 3D model is updated as part of digital compositing. For example, the processor unit 302 or the GPU 318 can layer the CGI asset on top of the selected video frame so that the CGI asset appears in the scene at an updated position based on the updated 3D model 354. In some examples, the compositing engine 316 can cause the processor unit 302 or the GPU 318 to convert the texture file data for the selected video frame back to video frame format for blending (e.g., layering) of the CGI on the selected video frame. Regardless of which technique or approach is used for digital compositing, the processor unit 302 or the GPU 318 can provide the composited video frame for the selected video frame for rendering on the display 314. When inserting a CGI asset into a video frame, the compositing engine 316 can use various techniques to ensure that the CGI asset matches the lighting, shadows, reflections, and other visual properties of the live-action footage. This can involve adjusting the color grading, applying depth of field or motion blur effects, and adjusting the transparency or blending modes of the CGI asset to ensure that it looks like a natural part of the scene.

Because the scene related information frame 334 is provided over the network 253 (e.g., LAN, WAN, and/or the Internet), the scene related information frame 334 can experience network latency. The network latency can add additional timing delay to the scene related information frame 334, such that the compositing engine 316 may select an incorrect scene related information frame. To compensate for network latency effects on the scene related information frame 334, the compositing engine 316 can communicate using a network interface (corresponding to one of the I/O interfaces 326) to ping each scene capture device that provided the scene related information frame 334. The compositing engine 316 can determine an amount of time it takes for ping data to travel from the computing platform 300 to a scene capture device and back. The amount of time can correspond to the network latency. The compositing engine 316 can adjust the timestamp for the scene related information frame 334 (from a given scene capture device) once it arrives over the network 353 at the computing platform 300 based on the determined network latency. The adjusted timestamps can then be evaluated in a same or similar manner as disclosed herein for identifying the nearest scene related information frame for the selected video frame (or selected texture frame data) for digital compositing.

In some examples, a scene capture device can be time synced with the video camera. For example, the scene capture device and the video camera can be configured with a timecode generator. Each timecode generator can generate a unique timecode signal that can be synchronized with a master timecode source. The master timecode source can be a standalone device, such as a timecode generator. Once the timecode generators are synchronized, the scene capture device can provide the scene related information frame 334 with a timestamp (or timecode) that is synchronized to the master timecode source. Similarly, the video camera can provide the video frame 328 with a timecode that is synchronized to the master timecode source. However, because a clock of the scene capture device is synced to a clock of its timecode generator, and clocks are known to drift overtime, the timestamp (or timecode) of each instance of the scene related information frame 334 provided by the scene capture device will be different from an expected time (if there was no drift).

Additionally, network latency can influence the timestamp (or timecode) of the scene related information frame 334 as this data travels over the network 353 to the computing platform 300 from the scene capture device. Because the compositing engine 316 is configured based on the video frame latency data 317, the compositing engine 316 can identify or select a video frame (or texture frame data) wherein sufficient time has been provided for the scene related information frame 334 to arrive at the computing platform 300 from the scene capture device. According to the examples disclosed herein, the compositing engine 316 can identify the nearest scene related information frame for the selected video frame (or selected texture frame data) in a same or similar manner as disclosed herein for digital compositing.

In some examples, the compositing engine 316 causes the processor unit 302 or the GPU 318 to adjust the timestamp of the scene related information frame 334 based on a frame delta value. The frame delta value can be representative of an amount of time between each scene related information frame provided by the scene capture device. Because an internal clock of the scene capture device is internally consistent, the delta value between timestamps of neighboring scene related information frames can be about the same for a period of time. Using the frame delta value, the compositing engine 316 can cause the processor unit 302 or the GPU 318 to adjust the timestamp of the scene related information frame 334 to compensate for drift of the scene capture device. If the compositing engine 316 determines that visual problems are increasing in the augmented video data 312, the compositing engine 316 can adjust the video frame latency automatically to reduce these visual effects, or in some instances, a user can provide updated video frame latency data identifying a new video frame latency for the computing platform 300. Thus, in some instances, the user can cause the computing platform 300 to vary an amount of visual problems that are in the augmented video data 312 based on the video frame latency data 317.

For example, the compositing engine 316 can provide a graphical user interface (GUI) or cause another module or device to provide the GUI with GUI elements for setting the video frame latency for the computing platform 300. The video frame latency set by the user based on the GUI can be provided as the video frame latency data 317. Accordingly, by controlling which video frame (or associated texture file) is used for digital compositing based on the video frame latency data 317 provides sufficient time so that the scene related information frame 334 can arrive from different scene capture devices being used in film production. A three (3) frame latency has been determined to provide sufficient time for different types of scene related information frames to arrive over the network 353 at the computing platform 300, in some instances. In addition, a three (3) frame latency has been determined to provide a sufficiently near-real time composited video to be useful in production to direct live action footage that will support CGI asset-live-action footage synchronization.

In some examples, the computing platform 300 is located on-site, that is, on the film set. In other examples, the computing platform 300 is located in a cloud environment. When the computing platform 300 is located in the cloud environment, the augmented video data 312 can be transmitted over a network to the display 314 that is located on the film set. In the present examples, although the components of the computing platform 300 are illustrated as being implemented on the same system, in other examples, the different components could be distributed across different systems (in some instances in the cloud computing environment) and communicate, for example, over a network.

In some examples, the display 314 is a camera viewfinder and thus the augmented video data 312 can be rendered to a camera operator, which in some instances can be the director. In some instances, the display 314 is one or more displays and includes the camera viewfinder and a display of a device, for example, a mobile device, such as a tablet, mobile phone, etc. In some instances, the one or more displays includes a display that is located in a video village, which is an area on a film set where film crew members can observe augmented and/or (raw) video footage as it is being filmed. The film crew members can watch the video footage, augmented and/or raw, and correct any potential identified film production problems (e.g., the actor is looking in the wrong direction).

Because during filming more than one video camera is used, in some examples, the compositing engine 316 can provide corresponding augmented video data (at a perspective of each digital video camera) in a same or similar manner as disclosed herein. In some instances, each video camera has its own computing platform similar to the computing platform 300, as shown in FIG. 3, for providing the corresponding augmented video data. In some examples, each video camera is jam-synced. For example, if the scene is being filmed by video cameras (more than one), the video cameras can be time synced electronically so that all of the digital video cameras provide video frames at a given instance of time with a same or similar timecode. For example, all of the video cameras can provide a given video frame at about the same time and thus with the same or similar timecode. In some examples, the timecode is a Society of Motion Picture and Television Engineers (SMPTE) timecode.

In some examples, the computing platform 300 can be dynamically adjusted based on the video frame latency data 317 so as new scene capture devices are used (e.g., on set, during filming, etc.), new scene related information frames can be synced with video frames to provide augmented video data 312 that has little to no visual problems. As such, as a frame rate (the rate at which the scene capture devices provided data) changes (e.g., higher or lower), the computing platform 300 can be configured to adapt to a new frame rate based on the video frame latency data 317 that is provided by the user.

In some examples, once the video frame 328 has been used by the computing platform 300, the compositing engine 316 can cause the processor unit 302 or the GPU 318 to remove the video frame 328 from a corresponding cache memory space. Thus, the compositing engine 316 can expire video frames and related data (e.g., metadata) no longer needed to free up locations in the corresponding cache memory space for new data/information, which can be processed according to the examples disclosed herein.

In some examples, the computing platform 300 may not receive the video frame 328, for example, if the digital video camera is offline, or the video frame 328 is unable to be provided to the computing platform 300. In these examples, the computing platform 300 can create artificial video frames with a timecode that can be processed and thus time-aligned with the scene related information frame 334 in a same or similar manner as disclosed herein. For example, if the director would like to adjust the CGI asset but does not require the scene, the computing platform 300 can be used to provide the CGI asset in the augmented video data 312 (in-shot) so that the director can make appropriate changes using the computing platform 300.

Accordingly, the computing platform 300 can provide an augmented shot of a scene at a given frame of latency (e.g., three (3) frame of latency) that is sufficient so that shots of a scene can be visualized during film production with little to no visual problems. The compositing engine 316 uses a data management and timecoding schema that enables for accurate alignment of non-frame data from various and dissimilar data sources (e.g., scene capture devices) with a video frame

FIG. 4 is a block diagram of an example of a system 400 for visualizing CGI video scenes. The system 400 can be used to provide real time augmented video data on a display 402, such as during filming. The augmented video data can correspond to the augmented video data 210, as shown in FIG. 2, or the augmented video data 312, as shown in FIG. 3. Thus, reference can be made to the example of FIGS. 1-3 in the example of FIG. 3. In the example of FIG. 4, the display 402 illustrates a composited video frame of the augmented video data (at an instance in time) that includes an image of a scene 404 captured by a video camera 406 with a digital asset 408 (e.g., a CGI asset). A computing platform 410 can be used to provide the augmented video data with one or more images in which digital assets have been incorporated therein. The composited video frame on the display 402 is exemplary and in other examples can include any number of digital assets or no digital assets at all (e.g., when the digital asset moves outside the scene or a field of view of the video camera 406). The computing platform 410 can correspond to the computing platform 300, as shown in FIG. 3, in some examples.

For example, the computing platform 410 can receive scene related data 412, which can include one or more scene related information frames, such as disclosed herein with respect to FIGS. 2-3. For example, the scene related data can include rig tracking data 414, which can be provided by a rig tracking system (or device) 416. The rig tracking system 416 can be used to track a rotation and position of a rig on which the video camera 406 is mounted. Example rigs can include a tripod, a handheld rig, a shoulder rig, an overhead rig, a POV rig, a camera dolly, a slider, rig, film crane, camera stabilizer, snorricam, etc. The rig tracking data 414 can characterize the rotation and position of the rig. The rig tracking data can also include a timestamp indicative of an instance in time at which the rotation and position of the rig was captured.

In some examples, the scene related data 412 can include body data 418, which can be provided by a body tracking system (or device) 420. The body tracking system 420 can be used to track a location of a person in the scene 404 in a body tracking coordinate system. The body data 418 can specify location information for the person in the body tracking coordinate system. In some examples, the body data 418 can specify rotational and/or joint information for each joint of the person. The body data 418 can also specify a position and orientation of the person in the body tracking coordinate system. The body tracking system 420 can provide the body data 418 with a timestamp indicating a time that body movements therein were captured. Example body tracking systems can include a motion capture suit, a video camera system (e.g., one or more cameras, such as from a mobile phone, used to capture body movements), etc. In examples wherein the body tracking system 420 is implemented as a video camera system, body movements captured by the video camera system can be extracted from images and provided as, or as part of the body data 418. Furthermore, in examples wherein the body tracking system 420 is implemented as a motion capture suit, the motion capture suit can be time synced with the video camera 406 or a number of video cameras 406 capturing the scene 404, and the body data 418 can include a timecode indicating a time that body movements were captured. In some examples, the facial data 422 can be used for animating the digital asset 408, for example, body movements of the digital asset 408.

In some examples, the scene related data 412 includes facial data 422, which can be provided by a facial tracking system 424. The facial data 422 can characterize movements of a person's face. The facial tracking system 424 can be implemented as a facial motion capture system. In some instances, the facial tracking system 424 includes a mobile device (e.g., a mobile phone) with software for processing images captured by a camera of the mobile device to determine facial characteristics and/or movements of the person. The facial tracking system 424 can provide the facial data 422 with a timestamp indicating a time that movements of the person's face were captured. The facial data 422 can be used for animating the digital asset 408, for example, facial expressions of the digital asset 408.

In some examples, the scene related data 412 includes prop data 426, which can be provided by a prop tracking system (or device) 428. In some examples, the prop tracking system 428 is the digital prop tracking system 100, as shown in FIG. 1. The prop tracking system 428 can be used to track one or more props in the scene 304. The prop tracking system 428 can provide the prop data 426 with a timestamp indicating a time that prop movements were captured. In some examples, the prop data 426 includes or corresponds to the prop spatial data 106, as shown in FIG. 1. In other examples, the prop spatial data 106 includes the timestamp indicating the time that one or more prop movements of one or more prop devices (e.g., such as the prop device 104, as shown in FIG. 1) were captured. In some examples, the prop data 426 and/or the prop spatial data 106 can include a starting pose for a character to be animated such as a CGI asset, a sword and shield to be held in someone's hand as they move, or an asset like a piece of furniture to be positioned in the scene.

In some examples, the computing platform 410 can receive digital asset data 430, which can correspond to the digital asset data 336, as shown in FIG. 3. For example, the digital asset data 430 can include CGI asset data and related information for animating one or more CGI assets (e.g., the digital asset 408) in a scene, such as the scene 404. In some examples, the digital asset data 430 includes controller data 432 provided by an asset controller 434. In one example, the asset controller 434 is an input device, for example, a controller. The asset controller 434 can be used to control movements and facial expression of the digital asset 408 in the scene 404. For example, the asset controller 434 can output controller data 432 characterizing the facial and/or body movements that the digital asset 408 is to implement. The controller data 432 can include a timecode indicating a time that the facial and/or body movements were captured. The controller data 432 can be used for animating the digital asset 408 (e.g., by the computing platform 410). In some examples, the controller data 432 can indicate a start and end time for a CGI action (e.g., movement and/or rotation). In some examples, a number of asset controllers can be used. For example, a first asset controller can be used to manipulate a torso of the digital asset 408, another asset controller for arms of the digital asset 408, and a further asset controller for manipulating finger movement of the digital asset 408, another asset controller device for manipulating lips of the digital asset 408, and so on. The controller data 432 from each of the asset controllers can be provided to the computing platform 410 for processing according to the examples disclosed herein. Accordingly, a number of different asset controllers can be used to control different portions of the digital asset 408, allowing for layering of different motions/movements of a digital asset into a single character.

In the example of FIG. 4, the video camera 406 provides video data 436 with one or more video frames with images of the scene 404. Each video frame can include a timecode. If a number of digital video cameras are used to capture the scene 404, the digital video cameras can be time synced as described herein. In some examples, a timecode can be generated from the computing platform 410 clock in cases where no timecode is present. This still allows for synchronization though can be less accurate than when using dedicated timecode devices. In some examples, the one or more video frames of the video data 436 can include the video frames 212, as shown in FIG. 2, and/or the video frame 328, as shown in FIG. 3.

The computing platform 410 can be implemented in a same or similar manner as the computing platform 400 to process the video data 436, the scene related data 412 and/or digital asset data 430 to provide the augmented video data, which is rendered in the example of FIG. 4 on the display 402. In some examples, the scene related data 412 includes the scene related information frames 214, as shown in FIG. 2, and/or the scene related information frame 334, as shown in FIG. 3. The computing platform 410 can provide an augmented shot of a scene at a given frame of latency (e.g., three (3) frames of latency) that is sufficient so that shots of a scene can be visualized during film production with little to no visual problems. By configuring the computing platform 410 with the data manager 242, as shown in FIG. 2, enables the computing platform 410 to accurately align non-frame data from various and dissimilar sources, such as the rig tracking system 416, the body tracking system 420, the facial tracking system 424, and the asset controller 434, with a video frame.

In some examples, the rig tracking data 414, the body data 418, the facial data 422, the prop data 426, the controller data 432 and the video data 436 are provided over a network 435, such as the network 353, as shown in FIG. 2. In other examples some or all of the data 414, 418, 422, 426, 432, and 436 are provided over the network 435. In some examples, the video camera 406 can be connected using a physical cable to the computing platform 410, which can be considered outside or not part of the network 435. In some examples, the video camera 406 and the systems 416, 420, 424, 428, and the asset controller 434 can be connected to the computing platform 410 using the network 435, which can include wired and/or wireless connections. For example, high bandwidth cables can be used to connect an HDMI output or SDI output of the video camera 406 to the computing platform 410 so as to transmit high resolution-video data at high rate to the computing platform 410. Example HDMI cables include, but are not limited to, HDMI 2.1 cable having a bandwidth of 48 Gbps to carry resolutions up to 10K with frame rates up to 120 fps (8K60 and 4K120). Example SDI cables include, but are not limited to, DIN 1.0/2.3 to BNC Female Adapter Cable. An external or internal hardware capture card (such as the internal PCI Express Blackmagic Design DeckLink SDI Capture Card or the external unit Matrox MAXO2 Mini Max for Laptops which supports a variety of video inputs such as HDMI HD 10-bit, Component HD/SD 10-bit, Y/C (S-Video) 10-bit or Composite 10-bit) can be employed to provide the video data 436 to an interface (e.g., one of the I/O interfaces 326, as shown in FIG. 3) of the computing platform 310.

In some examples, the system 400 can include a server 437, which can be coupled to the network 435, and the rig tracking data 414, the body data 418, the facial data 422, the prop data 426, the controller data 432 and the video data 436 can be routed through the server 437. For example, the server 437 can communicate with each system 416, 428, 420, 424 and/or the asset controller 434 and route data as messages to the computing platform 410. Thus, in some examples, the server can use a publisher/subscriber paradigm in which each system 416, 428, 420, 424 and/or the asset controller 434 are publishers and the computing platform is a subscriber. By way of further example, the server 437 can be implemented on a device, such as a laptop.

In some examples, the computing platform 410 can be used for post-production. For example, pre-recorded video data 438 with video frames can be processed in a same or similar manner as the video data 436 with other scene related information (data/frames) to provide augmented video data. For example, the computing platform 410 can be used to reanimate a live-take and insert a new digital asset (not used during production) into video footage (represented by the pre-recorded video data 438). In some examples, the computing platform 410 can be used to modify actions and/or a behavior of an inserted digital (e.g., such as the digital asset 408) initially used during production.

For example, the computing platform 410 can include a virtual environment builder 440 that can recreate or regenerate a 3D model 442 representative of a scene captured by one or more video cameras from which the pre-recorded video data 438 is provided based on environmental data 444 captured for the scene. The environmental data 444 can be provided by one or more environmental sensors, such as disclosed herein. An input device 446 can be used to provide commands/actions to a model updater 448 for adjusting one or more virtual features of the 3D model 442. The one or more virtual features can include a position/orientation of each virtual camera representative of a video camera from which the pre-recorded video data 438 is provided, position/orientation of a digital asset in the 3D model 442, and other types of virtual features. The computing platform 410 can include a digital compositor 450, which can be implemented in some instances similar to the digital compositor 208, as shown in FIG. 2. The digital compositor 450 can provide augmented video data based on the 3D model 442, and the pre-recorded video data 438. Accordingly, in some examples, the computing platform 410 can be used in post-production allowing for a reshoot of a scene by adjusting the 3D model 442 so that VFX (if available in the pre-recorded video data 438) can be modified or adjusted, or in some instances, insert into the pre-recorded video data 438 to provide the augmented video data. In some examples, the digital compositor 450 can include or communicate with the prop tracker engine 102, as shown in FIG. 1. The prop tracker engine 102 can be used to provide spatial data (e.g., a position, an orientation, and/or movement) for a digital asset to be composited by the digital compositor 450 to provide the scene 404.

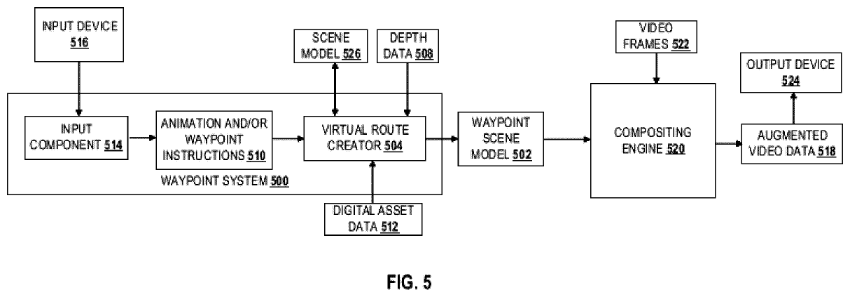

FIG. 5 is a block diagram of an example of a waypoint system 500 for animating (e.g., movements, actions, sounds, etc.) a digital asset (e.g.,. the digital asset 408, as shown in FIG. 4) in a scene (e.g., the scene 404, as shown in FIG. 4). Thus, reference can be made to the examples of FIGS. 1-4 in the example of FIG. 5. The waypoint system 500 can be implemented on a computing platform or in a cloud computing environment, as disclosed herein. The waypoint system 500 can provide waypoint scene model 502 identifying a number of virtual points (or locations) for the scene according to which a digital asset (e.g., a CGI asset) can be directed. Neighboring virtual points can define a virtual leg, and the virtual legs can be connected to define a virtual route or path for the digital asset. A given virtual point can be identified as a starting virtual point from which the digital asset can be animated. Another virtual point (in some instances the given virtual point) can identify an ending point at which animation of the digital asset ends. The waypoint scene model 502 can identify or specify animations of the digital asset along each virtual leg (in some instances at beginning and ending virtual points). In some instances, the animation of the digital asset along respective virtual legs can be different. For example, along a first virtual leg, the digital asset can be walking, and along a second virtual leg, the digital asset can be running. Other actions/movements are contemplated within the scope of the present disclosure.

The waypoint system 500 includes a virtual route creator 504. The virtual route creator 504 can provide the waypoint scene model 502 based on depth data 508, animation and/or waypoint instructions 510, and digital asset data 512. The depth data 508 can correspond to depth data, as disclosed herein (e.g., the depth data 508, as shown in FIG. 5). The depth data 508 can be used by the virtual route creator 504 to identify objects and surfaces in the scene for navigation of the digital asset according to the waypoint and/or animation instructions 510. In some examples, the virtual route creator 504 (or a different module/block-diagram, as disclosed herein) can be used to create a scene model 526 of the scene (based on the depth data 508). The scene model 526 can be populated with virtual location (point) information to provide the waypoint scene model 502 based on the animation and/or waypoint instructions 510. In some examples, the virtual route creator 504 receives the scene model 526 from the model generator 244, as shown in FIG. 2. Thus, in some implementations, the scene model 526 can correspond to the 3D model 234, as shown in FIG. 2. The virtual route creator 504 can provide the waypoint scene model 502 with virtual points defining a virtual path that can be behind and/or in front of objects (e.g., objects in the scene, such as props/non-props, as well as actors and/or animals) in the scene.

In yet other or additional examples, the waypoint scene model 502 can be miniaturized according to the examples herein to provide a diorama of the scene. Because the waypoint scene model 502 can include virtual points and thus define a virtual path for digital asset animation (or visualization), in some instances, the diorama can include the virtual points and the virtual path. In some examples, the diorama of the waypoint scene model 502 can be animated and allow a user (e.g., a producer) to visualize the animation of the digital asset along the virtual path.

The animation and/or waypoint instructions 510 can be provided by an input component 514. The input component 514 can include an interface (e.g., an application program interface (API), in some instances) for interfacing with an input device 516 for receiving the animation and/or waypoint instructions 510. The input device 516 can correspond to any device that can be used for animating the digital asset. In some examples, the input device 516 is a keyboard, or a controller (e.g., console controller). In some examples, the input device 516 is another system or server. The animation and/or waypoint instructions 510 can indicate an animation of the digital asset along each virtual leg, or the virtual path. The instructions 510 can also specify each virtual point (or waypoint) in the scene.

The virtual route creator 504 can update the scene model 526 to include the virtual points at locations in the model representative of desired locations in the scene. The updated scene model 526 can be referred to as the waypoint scene model 502. The virtual points can be connected to define a virtual path or trajectory for animation of the digital asset. The digital asset along one or more virtual legs of the virtual path can be unique from other or remaining virtual legs, in some embodiments. In some examples, the waypoint scene model 502 can be used for providing augmented video data 518 without the digital asset and depicting the virtual path (or a number of virtual legs of the virtual path) along which the digital asset can be animated. Providing the augmented video data 518 without the digital asset and only the virtual path (or a set of virtual legs of the virtual path) enables a producer (and/or other film making personnel) to adjust movements of the digital asset in a more efficient manner. In some examples, the virtual route creator 504 can insert the digital asset into the scene model 526 based on the digital asset data 512 to provide the waypoint scene model 502. The digital asset data 512 can characterize the digital asset, and in some instances, actions and/or movements of the digital asset. The waypoint scene model 502 can include data for animating along the virtual path, as defined by the virtual points, the digital asset, which can be provided based on the digital asset data 512. In other examples, the data can be associated (e.g., logically linked in memory, such as disclosed herein) with the waypoint scene model 502.

In some examples, the waypoint scene model 502 can be provided to a compositing engine 520. In some instances, the compositing engine 520 can be configured to implement one or more functions (or methods) of the digital compositor 112, as shown in FIG. 1, the digital compositor 208, as shown in FIG. 2, the compositing engine 316, as shown in FIG. 3, and/or the digital compositor 450, as shown in FIG. 4. The compositing engine 520 can receive one or more video frames 522 of the scene, and the waypoint scene model 502, which can be used to provide the augmented video data 518. In some examples, the compositing engine 520 can receive other information for compositing as well, for example, scene related information/data (e.g., one or more scene related frames, as disclosed herein), and/or the digital asset data 512, in some instances, to provide the augmented video data 518. In some examples, the compositing engine 520 can include or communicate with the prop tracker engine 102, as shown in FIG. 1. The compositing engine 520 can be used to provide spatial data (e.g., a position, an orientation, and/or movement) for the digital asset to be composited by the compositing engine 520 to provide the augmented video data 518.

The augmented video data 518 can include one or more composited video frames with the virtual locations and virtual legs between the virtual locations depicted in the scene. In some instances, the one or more composited video frames depict the virtual path along which the digital asset can be animated. In some examples, the virtual path can be modified based on user input, and provided to virtual route creator 504 to provide an updated waypoint scene model 502. For example, the input device 516 can be used in some instances to modify the virtual path and the user input can be provided as new or updated waypoint instructions.

The augmented video data 518 can be visualized on an output device 524, for example, as disclosed herein. In some examples, as described herein, the augmented video data 518 can include one or more composited video frames with only the virtual locations and/or the virtual path. In other examples, the augmented video data 518 can include one or more composited with the virtual path and the digital asset, which can be animated along the virtual path in the scene. For example, graphical user interface (GUI) elements can be rendered on the output device 524, which can be interacted with (e.g., by a user) to start and stop animation of the digital asset along the virtual path (or the set of virtual legs of the virtual path).

In some examples, a number of different virtual paths can be defined by the virtual route creator 504 for different digital assets in the scene model 526 based on the animation and/or waypoint instructions 510. For example, the virtual route creator 504 can create a first virtual path in the scene model 526 for a first digital asset, and a second virtual path in the scene model 526 for a second digital asset. In some instances, the virtual route creator 504 can evaluate the first and second virtual paths for any virtual path cross over (or intersection).

Because the first and second virtual paths can cross over, the first and second digital assets may cross over and one of the digital assets may occlude the other. Virtual route creator 504 can determine or identify any virtual path intersection (between any number of virtual paths in the scene model 526) and use occlusion ordering data to determine which of the first and second digital assets should be occluded by the other. The occlusion ordering data can indicate an order rendering of the first and second digital assets and thus can specify which of the first and second digital assets should occlude the other. In some examples, the virtual route creator 504 can use a depth sorting technique based on a depth or distance from a camera's viewpoint (e.g., that provides the one or more video frames 522). The virtual route creator 504 can provide the waypoint scene model 502 with data indicating the ordering of the first and second digital assets at virtual path intersections.

Accordingly, the waypoint system 500 allows for insertion of a virtual path into the scene, in some instances, along which the digital asset can be animated. This allows the producer (and/or other film personnel0, for example, during film production (e.g., filming on set), to visualize the virtual path that the digital asset will be animated so that scene errors can be identified and remedied during production (rather than post-production).

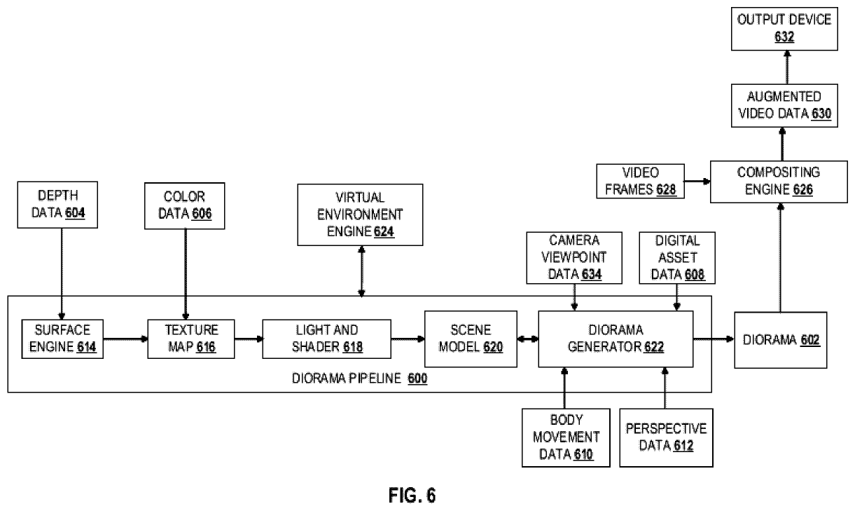

FIG. 6 is a block diagram of an example of a diorama pipeline 600 that can be used to provide a diorama 602 of a scene (e.g., the scene 404, as shown in FIG. 4) (a film set). In some examples, the diorama pipeline 600 can be implemented as part of the model generator 244, as shown in FIG. 2, in other instances, communicate with the model generator 244 to provide the diorama 602. Thus, reference can be made to the examples FIGS. 1-5 in the example of FIG. 6. The diorama pipeline 600 can be implemented on a computing platform or in a cloud computing environment, as disclosed herein.

The diorama pipeline 600 can provide the diorama 602 based on depth data 604, color data 606 (e.g., red, green, blue (RGB) information), digital asset data 608, and, in some instances, based on body movement data 610. The diorama 602 can be a digital representation of the scene that has been scaled (reduced) or miniaturized, in some implementations, with digital information (e.g., digital assets, for example, CGI assets, embedded therein). A virtual camera can be used for viewing the diorama 602 at a non-person point of view, and this virtual camera can be referred to as a “diorama view camera”. For example, the diorama pipeline 600 can receive perspective data 612, which can specify a perspective of the diorama view camera with respect to the diorama 602. The perspective data 612 can indicate a number of different non-person perspectives of the diorama 602, for example, a God view (a top-down perspective), a bird's eye view, or a worm's eye view.

For example, the diorama pipeline 600 includes a surface engine 614. The surface engine 614 can receive the depth data 604. The surface engine 614 can process the depth data 604 to reconstruct (digitally) one or more surfaces in the scene (e.g., of objects and/or an environment of the scene) to provide a surface model. The surface model can represent geometric details provided by the depth data 604 (e.g., point cloud data). The surface model can thus approximate a shape and a geometry of objects and/or the environment of the scene.

For example, the surface engine 614 can convert a point cloud provided as the depth data 604 into a surface mesh or a set of interconnected triangles to represent the one or more surfaces in the scene to provide the surface model. The surface engine 614 can use any type of algorithm for providing the surfaces. For example, the surface engine 614 can use Poisson reconstruction, marching cubes, Delaunay triangulation, or a different type of algorithm. A point cloud can represent a 3D collection of points that describe surfaces in the scene. Each point in the point cloud can correspond to a specific location in space (in the scene) and can include (or be associated with) information about its position and distance from a camera. A density of points in the point cloud can vary depending on a capturing method and resolution of a sensor or a camera.

In some examples, the diorama pipeline 600 includes a texture map component 616 that can receive the surface model for texture surface mapping. For example, the texture map component 616 can use the color data 606 to map textures to the surface model to provide a texture-mapped surface model. The color data 606 can be provided from a color camera or sensors that can in some instances be synchronized with depth-sensing technology used for providing the depth data 604. These devices can capture depth (distance) and color information simultaneously, for example, using stereo vision, structured light, or RGB-D sensors.

For example, during a capture process, each point in the point cloud can be associated with a corresponding RGB value that represents the color of that point in the scene. These RGB values can be aligned with the depth data 604, ensuring that color information matches spatial coordinates of the points. When it comes to mapping the textures onto the surface mesh, the correspondence between the RGB information and the mesh surfaces can be established through UV mapping or texture coordinates. UV mapping is a technique used to define a 2D coordinate system (U and V) on the surface mesh. The UV coordinates can then be used by the texture map component 616 to project or map RGB values (of the color data 606) onto corresponding vertices of the surface mesh. Various algorithms can be used by the texture map component 616 for texture mapping, including, but not limited to, nearest-neighbor mapping, barycentric mapping, or more advanced techniques, such as mesh parameterization or surface parameterization.

In some examples, the diorama pipeline 600 includes a light and shader component 618. The light and shader component 618 can apply light and/or shading to the texture-mapped surface model to provide a scene model 620, as shown in FIG. 6. For example, the shader component 618 can add lighting and shading effects to the textured-mapped surface model to enhance its realism. In some examples, the shader component 618 can be omitted and the texture-mapped surface model can be provided as the scene model 620. The scene model 620 can be used to represent the scene and thus to resemble an appearance and characteristics of a real-world environment on which it is based on. In some examples, the scene model 620 can correspond to the 3D model 234, as shown in FIG. 2.

While the example of FIG. 6 illustrates the surface engine 614, the texture map component 616 and the light and shader component 618 as part of the diorama pipeline 600, in other examples, these block-diagrams can be implemented as stand-alone or as part of a system (e.g., compositing system, or a different system), which the diorama pipeline 600 can communicate with.

The diorama pipeline 600 can include a diorama generator 622 that can provide the diorama 602 based on the scene model 620, the digital asset data 608, the body movement data 610, and the perspective data 612. The diorama generator 622 can create a miniaturized version of the scene (e.g., prior and/or during filming) corresponding to providing (or generating) the diorama 602. The diorama generator 622 can create a reduced-scaled version of the scene model 620. A virtual world (or environment) can be defined to provide a digital space in which digital models and/or data can be positioned. In some examples, the virtual world includes the diorama 602. The virtual world can be created by a virtual environment engine 624. In some examples, the diorama pipeline 600 includes the virtual environment engine 624. The diorama view camera can be inserted into the digital space. The diorama view camera position and/or orientation with respect to the diorama 602 can be adjusted based on the perspective data 612. The diorama view camera can be adjusted in the digital space to provide a non-person viewpoint (e.g., God view) of the diorama 602.

In some examples, the diorama generator 622 can receive the animation and/or waypoint instructions 510, as shown in FIG. 5, and use this data for insertion of waypoints (virtual points) into the scene model 620 to define a virtual path therein. A digital asset can be animated along the virtual path, as disclosed herein. Thus, in some examples, the diorama pipeline 600 can include the waypoint system 500 and use the animation and/or waypoint instructions 510 for waypoint insertion, and digital asset virtual path animation, in some instances.

In some examples, the diorama generator 622 can insert one or more digital assets into the scene model 620 based on the digital asset data 608, and provide data for animating the inserted digital assets over time. The data can be provided as part of the diorama 602, or can be logically linked in memory (as disclosed herein) to the diorama 602. For example, a first digital asset can be inserted into the scene model 620 that can represent a digital asset (e.g., CGI asset) that is inserted into the scene, which can be referred to as a scene digital asset. The scene digital asset can be inserted into the scene (scene shot), in some instances, using a compositing engine 626. The compositing engine 626 can be configured to implement one or more functions (or methods) of the digital compositor 112, as shown in FIG. 1, the digital compositor 208, as shown in FIG. 2, the compositing engine 316, as shown in FIG. 3, the digital engine 450, as shown in FIG. 5, and/or the compositing engine 520, as shown in FIG. 5. In some examples, the compositing engine 626 can include or communicate with the prop tracker engine 102, as shown in FIG. 1. The compositing engine 626 can be used to provide spatial data (e.g., a position, an orientation, and/or movement) for the digital asset to be composited by the compositing engine 520 to provide the augmented video data 630. In some examples, a second digital asset can be inserted into the scene model 620 that can represent an actor (or other elements in the scene) and movements of the actor can be mapped to the second digital asset using the body movement data 610. In some examples, the body movement data 610 corresponds to the body data 418, as shown in FIG. 4. The diorama 602 can be animated or still frames can be provided of the diorama 602 to enable a user (e.g., director) to visualize the scene (represented digitally) through a non-person viewpoint based on the scene model 620.

In some examples, the compositing engine 626 can receive one or more video frames 628 for digital compositing according to one or more examples, as disclosed herein. The compositing engine 626 can provide augmented video data 630 based on the video frames 628 and the diorama 602. The one or more video frames can be provided by a camera, in some instances, as disclosed herein. By way of example, the camera can correspond to a camera on a portable device, for example, a tablet or a mobile phone. For example, the one or more video frames can include a captured table, and the compositing engine 626 can render the diorama 602 on the table. In some examples, the video frames are captured shots of the scene. In other examples, the video frames are non-scene shots, for example, at a director location (or a room, area, etc.) used for production.

The compositing engine 626 can provide the augmented video data 630 with one or more composited video frames. The composited video frames can include the diorama 602 rendered from a resulting perspective view (a non-person viewpoint) of the diorama view camera. The augmented video data 630 can be rendered on an output device 632, as shown in FIG. 6. The output device 632 can correspond to a viewfinder on a camera, a display, a television, a VR headset, a portable device (e.g., a portable computer, a tablet, a mobile phone, etc.), or any other visual output device capable of rendering composited video frames.

In some instances, the scene model 620 can be simulated and the augmented video data 630 can provide the composited video frames with the diorama 602 mimicking the simulated scene model 620 enabling a user (e.g., the producer) to visualize a shot of the scene from the non-person viewpoint (e.g., a God's view) while one or more digital assets therein are animated (or simulated). In examples in which the second digital asset is used, the augmented video data 630 can include the second digital asset representative of the actor in the diorama 602, and mimic (or represent) movements of the actor as the actor was being filmed.

In some examples, audio can be captured of the actor as the actor is being filmed, and synced (by the compositing engine 626 or a different module) with the movement of the second digital asset (corresponding to movements of the actor). In some examples, one or more GUI elements can be rendered on the output device 632 to enable a user (e.g., the director) to start and stop animation of the diorama 602. By providing the GUI elements allows for controlling the animation of the diorama 602 and enables the user to step through (e.g., go forward and back in time with respect to the diorama 602). Additionally, a GUI element (e.g., a stop GUI element) can be used to enable the user to stop the animation of the diorama 602 at a particular instance in time for further investigation (e.g., correcting digital asset placement, actor actions and/or placements, etc.) In some instances, the diorama 602 can be rendered on the output device 632 without being combined with other data, for example, the video frames 628 and the digital asset data 608. Thus, in some examples, the compositing engine 626 can provide frames of the diorama 602 that can be output on the output device 632 for visualization.

In some examples, the diorama generator 622 can use camera viewpoint data 634 for the camera that provided the video frames 628 for setting (or configuring) the diorama view camera with respect to the diorama 602. For example, the camera viewpoint data 634 can provide position and/or orientation information for the camera, and in some instances other camera information as well (e.g., a field of view, a lens distortion, a sensor size, etc.) that can be used for setting the diorama view camera. For example, the diorama generator 622 can adjust the diorama view camera and thus a profile view of the scene model 620 based on the camera viewpoint data 634 to provide the diorama 602 at a particular orientation with respect to the diorama view camera.

For example, if an observer (e.g., director) wants to view the diorama 602 on the output device 632 from a left-side at a particular angle, the diorama generator 622 can provide the diorama 602 on the output device 632 so that the observer can see (view) the diorama 602 at that particular angle. Thus, the observer can view the diorama 602 at different non-person perspectives (e.g., beyond just a top-down view wherein the particular angle with respect to diorama 602 can be zero). The observer can view the diorama 602 at oblique or slanted views.

In some examples, a number of cameras are used to provide respective video frames at different recording (or capturing) perspectives. The compositing engine 626 (or a respective compositing engine) can be used to provide corresponding augmented video data with a respective diorama 602 therein at a viewing angle (or view profile) that can be based on camera viewpoint data for a given camera. For example, if two observers are viewing the diorama 602, one of the observers can view the diorama 602 on the output device 632 at one slanted/oblique view, while another observer of the observers can view the diorama on another output device at a different slanted/oblique view.

For example, if the diorama 602 is rendered on the table captured by the one or more video frames provided by first and second cameras, a first output device can show the diorama 602 at one view (e.g., from a left hand side at an angle with respect to the diorama 602) and a second output device can show the diorama 602 at a different view (e.g., from a right hand side at an angle with respect to the diorama 602). This enables a number of different film personnel (e.g., directors, producers, etc.) to visualize the scene from their own device perspective through the diorama 602, for example, before filming, or while filming is on-going.

Because the diorama 602 provides a non-person viewpoint of the scene with digital asset information (in some instances representative of the actor), producers (and/or other film industry personnel) are able to visualize the scene prior or during filming. Movements of actors and objects in the scene (e.g., a car, a plane, etc.) can be viewed through a non-traditional viewpoint. For example, a God view of the scene provided by the diorama 602 would enable the producer to determine whether movements of the actor and/or digital asset need correction or adjusting. Additionally, the God view of the scene provided by the diorama 602 would enable the producer to correct actor and/or object placement in the scene, for example, adjust prop locations. Thus, the God view of the scene provided by the diorama 602 would allow the producer to consider a number of different actions/elements of the scene simultaneously, a feature that is absent from traditional on-set first person or third person views of a scene.

For example, the God view of the scene through the diorama 602 would provide the producer better overall visibility of the scene (e.g., when understanding of a scene space is needed or desired), improve scene planning (e.g., decision making), and object placement/management, spatial awareness (e.g., making it easier to understand the scene, relationship between objects, actors, and/or digital assets), and macro-level control (e.g., allowing the producer to manage multiple actors and/or digital assets simultaneously, for example, orchestrating their movements and interactions with a higher degree of precision). Moreover, because the diorama 602 can be simulated or animated, the producer can be provided with an on set depiction (in a digital domain) of how the scene was captured. This enables the producer to make corrections during filming and thus reduce post-production costs as errors and mistakes can be captured upfront, that is, during filming, rather after filming/post-production.

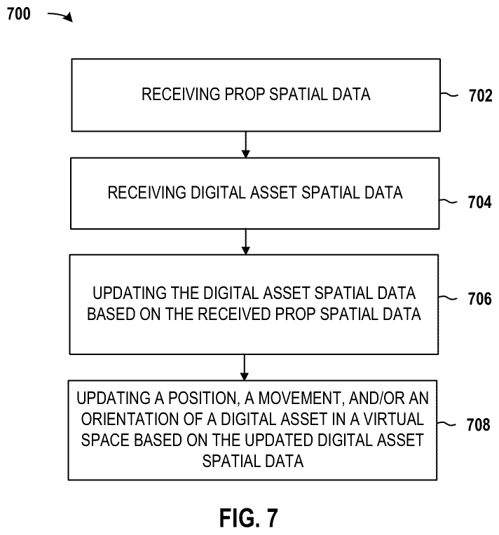

In view of the foregoing structural and functional features described above, an example method will be better appreciated with reference to FIGS. 7-12. While, for purposes of simplicity of explanation, the example methods of FIGS. 7-12 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods.

FIG. 7 is an example of a method 700 for providing a composited video frame. The method 700 can be implemented by the prop tracker engine 102, as shown in FIG. 1. Thus, reference can be made to one or more examples of FIGS. 1-6 in the example of FIG. 7. The method 700 can begin at 702 by receiving prop spatial data (e.g., the prop spatial data 106, as shown in FIG. 1) for a prop device (e.g., the probe device 104, as shown in FIG. 1) in a physical space. At 704, digital asset spatial data (e.g., the digital asset spatial data 108, as shown in FIG. 1) for a digital asset in a virtual space. At 706, the digital asset spatial data for the digital asset can be updated based on the prop spatial data to provide updated digital asset spatial data (e.g., the updated digital asset spatial data 110, as shown in FIG. 1). At 708, a position, a movement, and/or an orientation of the digital asset in the virtual space can be updated based on the updated spatial data for the digital asset.

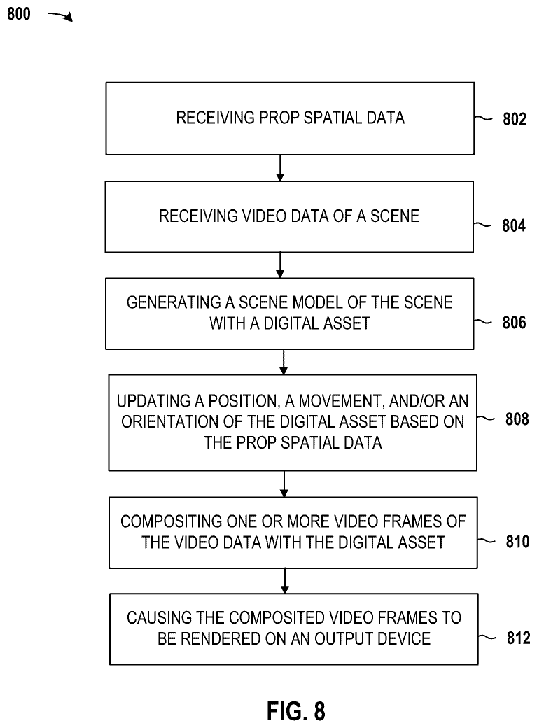

FIG. 8 is an example of a method 800 for providing augmented video data during production using digital asset prop tracking. The method 800 can be implemented by components and/or systems, as disclosed herein. Thus, reference can be made to one or more examples of FIGS. 1-7 in the example of FIG. 8. The method 800 can begin at 802 by receiving (e.g., at the prop tracker engine 102, as shown in FIG. 1) prop spatial data (e.g., the prop spatial data 106, as shown in FIG. 1) for a prop device in a scene. At 804, video data (e.g., the video data 116, as shown in FIG. 1) that includes video frames captured of the scene can be received (e.g., by the digital compositor 112, as shown in FIG. 1). At 806, a scene model (e.g., the 3D model 234, as shown in FIG. 2) of the scene with a digital asset can be generated (e.g., by the model generator 244, as shown in FIG. 2). At 808, a position, orientation, and/or movement of the digital asset in the scene model can be updated (e.g., by the prop tracker engine 102) based on the prop spatial data. At 810, one or more video frames of the received video data and the digital asset with the updated position, movement, and/or orientation can be composited (e.g., by the digital compositor 112). At 812, the composited video frames can be caused (e.g., by the digital compositor 112) to be rendered on an output device (e.g., the output device 120, as shown in FIG. 1).

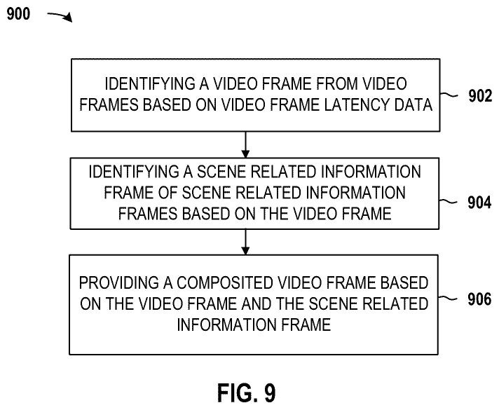

FIG. 9 is an example of a method 900 for providing a composited video frame. The method 900 can be implemented by the compositing engine 200, as shown in FIG. 1, or the compositing engine 316, as shown in FIG. 3. Thus, reference can be made to one or more examples of FIGS. 1-8 in the example of FIG. 9. The method 900 can begin at 902 with a video frame (e.g., one of the video frames 212, as shown in FIG. 2) from video frames stored in a cache memory space (e.g., the cache memory space 204, as shown in FIG. 2) being identified (e.g., by the video frame retriever 220, as shown in FIG. 2) based on video frame latency data (e.g., the video frame latency data 224, as shown in FIG. 2). The video frame latency data can specify a number of video frames to be stored in the cache memory space before the video frame is selected. At 904, a scene related information frame (e.g., one of the scene related information frames 214, as shown in FIG. 2) of the scene related information frames can be identified (e.g., by the scene related frame retriever 226, as shown in FIG. 2) based on a timecode of the video frame. At 906, a composited video frame (e.g., that is part of the augmented video data 110, as shown in FIG. 1) can be provided based on the video frame and the scene related information frame.

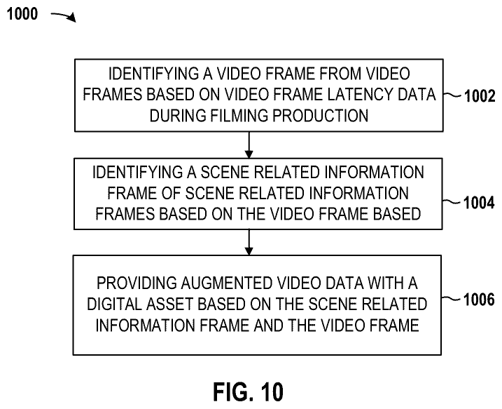

FIG. 10 is an example of a method 1000 for providing augmented video data during a previsualization of a scene. The method 1000 can be implemented by the compositing engine 200, as shown in FIG. 2, or the compositing engine 316, as shown in FIG. 3. Thus, reference can be made to one or more examples of FIGS. 1-9 in the example of FIG. 10. The method 1000 can begin at 1002 by identifying a video frame (e.g., one of the video frames 212, as shown in FIG. 2) from video frames provided by a video camera (e.g., the camera 406, as shown in FIG. 4) representative of a scene (e.g., the scene 404, as shown in FIG. 4) during filming production based on video frame latency data (e.g., the video frame latency data 224, as shown in FIG. 2). The video frame latency data can specify a number of video frames to be stored in memory of a computing platform before the video frame is selected.

At 1004, a scene related information frame (e.g., one of the scene related information frames 214, as shown in FIG. 2) of scene related information frames provided by scene capture devices (e.g., of one of the systems 416, 420, 324, and/or 428, and/or the asset controller 434, as shown in FIG. 4) can be identified (e.g., by the scene related frame retriever 226, as shown FIG. 2) based on an evaluation of a timecode of the video frame relative to a timestamp of the scene related information frames. The timestamp for the scene related information frames can be generated based on a frame delta value representative of an amount of time between each scene related information frame provided by a respective scene capture device of the scene capture devices. At 1006, augmented video data (e.g., the augmented video data 210, as shown in FIG. 2) with a digital asset (e.g., the digital asset 208, as shown in FIG. 1) based on the scene related information frame and the video frame can be provided (e.g., for rendering on an output device, such as the display 314, as shown in FIG. 3, or the display 402, as shown in FIG. 4).

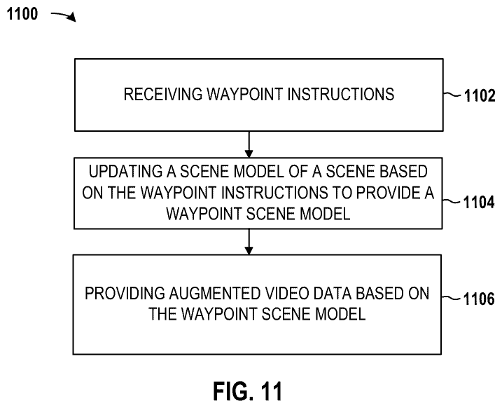

FIG. 11 is an example of a method 1100 for waypoint animation of a digital asset in a scene. The method 1100 can be implemented by one or more block diagrams (or modules), for example, with respect to FIG. 5. Thus, reference can be made to one or more examples of FIGS. 1-10 and in the example of FIG. 11. The method 1100 can begin at 1102 by receiving (e.g., by the virtual route creator 504, as shown in FIG. 5) waypoint instructions (e.g., the animation and/or waypoint instructions 510, as shown in FIG. 5). The waypoint instructions can identify virtual points (waypoints) for a digital asset for use in a scene (e.g., the scene 404, as shown in FIG. 4). At 1104, updating a scene model (e.g., the scene model 526, as shown in FIG. 5) to include the virtual points at locations in the scene model corresponding to locations in the scene to provide a waypoint scene model (e.g., the waypoint scene model 502, as shown in FIG. 5). At 1106, augmented video data (e.g., the augmented video data 518, as shown in FIG. 5) can include one or more composited video frames with the virtual points in the scene can be provided (e.g., the compositing engine 520, as shown in FIG. 5) based waypoint scene model. The augmented video data can be rendered or caused to be rendered on an output device (e.g., the output device 524, as shown in FIG. 5) for visualization.

In some examples, at 1102, animation instructions (e.g., the animation and/or waypoint instructions 510) can be received identifying an animation of a digital asset between neighboring virtual points of the virtual points. The waypoint scene model can be provided at step 1104 with data specifying the animation of the digital asset between the neighboring virtual points. At 1106, the augmented video data with the composited frames can be rendered (or caused to be rendered) on an output device to provide a visual animation of the digital asset at and/or between the neighboring points based on the waypoint scene model.

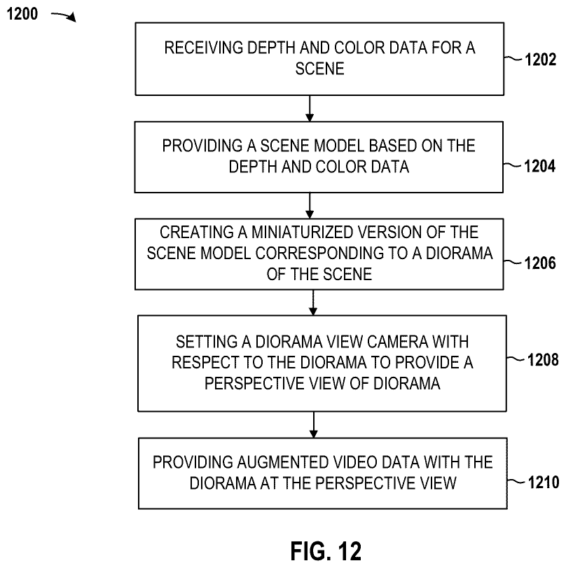

FIG. 12 is an example of a method 1200 for outputting augmented video data with a diorama (e.g., the diorama 602, as shown in FIG. 6). The method 1200 can be implemented by one or more block diagrams (or modules), for example, with respect to FIG. 12. Thus, reference can be made to one or more examples of FIGS. 1-11 in the example of FIG. 12. The method 1200 can begin at 1202 by receiving (e.g., by the diorama pipeline 1200, as shown in FIG. 12) depth and color data (e.g., the depth and color data 604 and 606, as shown in FIG. 6) for a scene (e.g., the scene 404, as shown in FIG. 4). At 1204, a scene model (e.g., the scene model 620, as shown in FIG. 6) can be provided (e.g., by the diorama pipeline 600) based on the depth and color data. The scene model can provide a virtual (or digital) representation of the scene, including objects and/or other elements in the scene. At 1206, a miniaturized version of the scene model corresponding to a diorama of the scene can be created (e.g., by the diorama pipeline 500).

At 1208, a diorama view camera (digital video camera) can be set (e.g., by the diorama pipeline 600, for example, based on the perspective data 612, as shown in FIG. 6) with respect to the diorama to provide a perspective view of the diorama. At 1210, providing augmented video data (e.g., the augmented video data 630, as shown in FIG. 6) comprising one or more composited video frames with the diorama at the perspective view for visualization on an output device (e.g., the output device 632, as shown in FIG. 6).

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 13. Furthermore, portions of the embodiments may be a computer program product on a computer-usable storage medium having computer readable program code on the medium. Any non-transitory, tangible storage media possessing structure may be utilized including, but not limited to, static and dynamic storage devices, hard disks, optical storage devices, and magnetic storage devices, but excludes any medium that is not eligible for patent protection under 35 U.S.C. § 101 (such as a propagating electrical or electromagnetic signal per se). As an example and not by way of limitation, a computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, where appropriate.

In this regard, FIG. 13 illustrates one example of a computing system 1300 that can be employed to execute one or more embodiments of the present disclosure. Computing system 1300 can be implemented on one or more general purpose networked computer systems, embedded computer systems, routers, switches, server devices, client devices, various intermediate devices/nodes or standalone computer systems. Additionally, computing system 1300 can be implemented on various mobile clients such as, for example, a personal digital assistant (PDA), laptop computer, pager, and the like, provided it includes sufficient processing capabilities. In other examples, the computing system 1300 can be implemented on dedicated hardware.

Computing system 1300 includes processing unit 1302, memory 1304, and system bus 1306 that couples various system components, including the memory 1304, to processing unit 1302. Dual microprocessors and other multi-processor architectures also can be used as processing unit 1302. System bus 1306 may be any of several types of bus structure including a memory bus or memory controller, a peripheral bus, and a local bus using any of a variety of bus architectures. Memory 1304 includes read only memory (ROM) 1310 and random access memory (RAM) 1312. A basic input/output system (BIOS) 1314 can reside in ROM 1310 containing the basic routines that help to transfer information among elements within computing system 1300.

Computing system 1300 can include a hard disk drive 1316, magnetic disk drive 1318, e.g., to read from or write to removable disk 1320, and an optical disk drive 1322, e.g., for reading CD-ROM disk 1324 or to read from or write to other optical media. Hard disk drive 1316, magnetic disk drive 1318, and optical disk drive 1322 are connected to system bus 1306 by a hard disk drive interface 1326, a magnetic disk drive interface 1328, and an optical drive interface 1330, respectively. The drives and associated computer-readable media provide nonvolatile storage of data, data structures, and computer-executable instructions for computing system 1300. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein. The computing system 1300 can include a GPU interface 1358, which can be used for interface for interfacing with a GPU 1360. In some examples, the GPU 1360 can correspond to the GPU 318, as shown in FIG. 3. In further examples, the computing system 1300 includes the GPU 1360.

A number of program modules may be stored in drives and RAM 1310, including operating system 1332, one or more application programs 1334, other program modules 1336, and program data 1338. For example, the RAM 1310 can include one or more block diagrams (or modules) as disclosed herein. The program data 1332 can include one or more types of data, as disclosed herein.

A user may enter commands and information into computing system 1300 through one or more input devices 1340, such as a pointing device (e.g., a mouse, touch screen), keyboard, microphone, joystick, game pad, scanner, and the like. For example, the one or more input devices 1340 can be used to provide the video frame latency data, as disclosed herein. These and other input devices are often connected to processing unit 1302 through a corresponding port interface 1342 that is coupled to the system bus, but may be connected by other interfaces, such as a parallel port, serial port, or universal serial bus (USB). One or more output devices 1344 (e.g., display, a monitor, printer, projector, or other type of displaying device) is also connected to system bus 1306 via interface 1346, such as a video adapter.

Computing system 1300 may operate in a networked environment using logical connections to one or more remote computers, such as remote computer 1348. Remote computer 1348 may be a workstation, computer system, router, peer device, or other common network node, and typically includes many or all the elements described relative to computing system 1300. The logical connections, schematically indicated at 1350, can include a local area network (LAN) and a wide area network (WAN). When used in a LAN networking environment, computing system 1300 can be connected to the local network through a network interface or adapter 1352. When used in a WAN networking environment, computing system 1300 can include a modem, or can be connected to a communications server on the LAN. The modem, which may be internal or external, can be connected to system bus 1306 via an appropriate port interface. In a networked environment, application programs 1334 or program data 1338 depicted relative to computing system 1300, or portions thereof, may be stored in a remote memory storage device 1354.

Although this disclosure includes a detailed description on a computing platform and/or computer, implementation of the teachings recited herein are not limited to only such computing platforms. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models (e.g., software as a service (Saas, platform as a service (PaaS), and/or infrastructure as a service (IaaS)) and at least four deployment models (e.g., private cloud, community cloud, public cloud, and/or hybrid cloud). A cloud computing environment can be service oriented with a focus on statelessness, low coupling, modularity, and semantic interoperability.

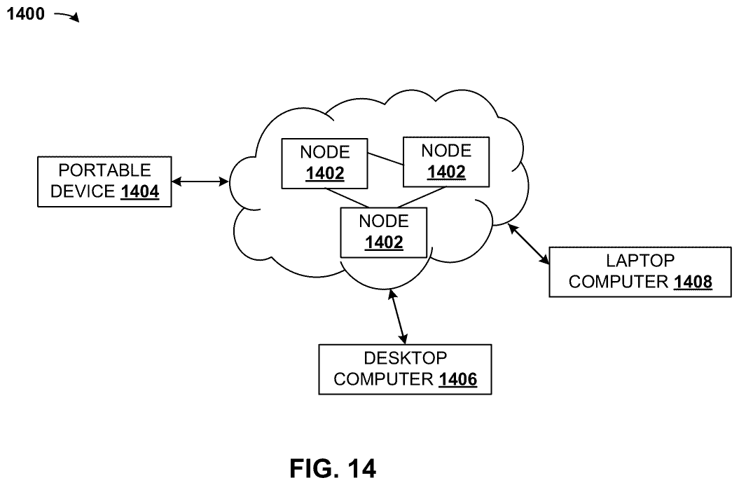

FIG. 14 is an example of a cloud computing environment 1400 that can be used for implementing one or more modules and/or systems in accordance with one or more examples, as disclosed herein. Thus, reference can be made to one or more examples of FIGS. 1-13 in the example of FIG. 14. As shown, cloud computing environment 1400 can include one or more cloud computing nodes 1402 with which local computing devices used by cloud consumers (or users), such as, for example, personal digital assistant (PDA), cellular, or portable device 1404, a desktop computer 1406, and/or a laptop computer 1408, may communicate. The computing nodes 1402 can communicate with one another. In some examples, the computing nodes 1402 can be grouped (not shown) physically or virtually, in one or more networks, such as Private, Community, Public, or Hybrid clouds, or a combination thereof. This allows the cloud computing environment 1400 to offer infrastructure, platforms and/or software as services for which a cloud consumer does not need to maintain resources on a local computing device. The devices 1404-1408 are intended to be illustrative and that computing nodes 1402 and cloud computing environment 1400 can communicate with any type of computerized device over any type of network and/or network addressable connection (e.g., using a web browser). In some examples, the one or more computing nodes 1402 are used for implementing one or more examples disclosed herein for processing and computing data. Thus, in some examples, the one or more computing nodes can be used to implement modules, platforms, and/or systems, as disclosed herein.

In some examples, the cloud computing environment 1400 can provide one or more functional abstraction layers. It is understood that the cloud computing environment 1400 need not provide all of the one or more functional abstraction layers (and corresponding functions and/or components), as disclosed herein. For example, the cloud computing environment 1400 can provide a hardware and software layer that can include hardware and software components. Examples of hardware components include: mainframes; RISC (Reduced Instruction Set Computer) architecture based servers; servers; blade servers; storage devices; and networks and networking components. In some embodiments, software components include network application server software and database software.

In some examples, the cloud computing environment 1400 can provide a virtualization layer that provides an abstraction layer from which the following examples of virtual entities may be provided: virtual servers; virtual storage; virtual networks, including virtual private networks; virtual applications and operating systems; and virtual clients. In some examples, the cloud computing environment 1400 can provide a management layer that can provide the functions described below. For example, the management layer can provide resource provisioning that can provide dynamic procurement of computing resources and other resources that are utilized to perform tasks within the cloud computing environment. The management layer can also provide metering and pricing to provide cost tracking as resources are utilized within the cloud computing environment 1400, and billing or invoicing for consumption of these resources. In one example, these resources may include application software licenses. Security provides identity verification for cloud consumers and tasks, as well as protection for data and other resources. The management layer can also provide a user portal that provides access to the cloud computing environment 1400 for consumers and system administrators. The management layer can also provide service level management, which can provide cloud computing resource allocation and management such that required service levels are met. Service Level Agreement (SLA) planning and fulfillment can also be provided to provide pre-arrangement for, and procurement of, cloud computing resources for which a future requirement is anticipated in accordance with an SLA.

In some examples, the cloud computing environment 1400 can provide a workloads layer that provides examples of functionality for which the cloud computing environment 1400 may be utilized. Examples of workloads and functions which may be provided from this layer include: mapping and navigation; software development and lifecycle management; virtual classroom education delivery; data analytics processing; and transaction processing. Various embodiments of the present disclosure can utilize the cloud computing environment 1400.

### Additional Embodiments

Embodiments disclosed herein include:

A. A computer-implemented method comprising: providing a scene model that is a virtual representation of a scene based on depth and color data captured for the scene; creating a miniaturized version of the scene model corresponding to a diorama of the scene; setting the virtual camera with respect to the scene model to provide a perspective view of the diorama; and causing the diorama of the scene to be outputted at the perspective view on an output device.

B. A computer-implemented method comprising: receiving waypoint instructions identifying virtual points for a digital asset for use in a scene; updating a scene model to include the virtual points at locations in the scene model corresponding to locations in the scene to provide a waypoint scene model; providing augmented video data comprising one or more composited video frames with the virtual points in the scene based waypoint scene model; and causing the augmented video data to be rendered on an output device.

C. A computer-implemented method comprising: receiving prop spatial data for a prop device in a physical space; receiving digital asset spatial data for a digital asset in a virtual space; updating the spatial data for the digital asset based on the prop spatial data; and updating a position, a movement, and/or an orientation of the digital asset in the virtual space based on the updated spatial data for the digital asset.

D. A method comprising: receiving prop spatial data for a prop device in a scene; receiving video data comprising video frames captured of the scene; generating a scene model of the scene with a digital asset; updating a position, orientation, and/or movement of the digital asset in the scene model based on the prop spatial data; compositing one or more video frames of the received video data and the digital asset with the updated position, movement, and/or orientation; and causing the composited video frames to rendered on output device.

Each of embodiments A through D may have one or more of the following additional elements in any combination: Element 1: wherein said causing comprises generating augmented video data comprising one or more composited video frames with the diorama; Element 2: wherein said generating augmented video data comprises compositing one or more video frames provided by a video camera and the diorama to provide the augmented video data; Element 3: wherein the virtual camera is further set based on camera viewpoint data for the video camera to specify the perspective view of the diorama; Element 4: wherein the perspective view includes a top down view, an oblique view, or a slanted view; Element 5: wherein the camera is a first video camera, the output device is a first output device, the virtual camera is a first virtual camera, and the perspective view is a first perspective view, and the method further comprising: setting a second virtual camera in the virtual environment with respect to the scene model to provide a second perspective view of the diorama based on camera viewpoint data for a second video camera; and causing the diorama of the scene at the second perspective to be rendered on a second output device; Element 6: wherein the first and second output devices are mobile devices; Element 7: inserting one or more digital assets into the scene model representative of digital assets to be used in the scene; Element 8: wherein the one or more digital assets is a first digital asset, the method further comprising insert a second digital asset representative of an actor into the scene model, wherein movements of the second digital asset in the scene model are synced to movements of the actor; Element 9: wherein the diorama is animated to provide a visual representation of the scene; Element 10: further comprising receiving animation instructions identifying an animation of a digital asset between neighboring virtual points of the virtual points, wherein the waypoint scene model is provided with data specifying the animation of the digital asset between the neighboring virtual points; Element 11: wherein said providing comprises generating the augmented video data with composited frames with the virtual points in the scene and the digital asset between the neighboring virtual points; Element 12: wherein said causing comprises causing the augmented video to be rendered on the output device to provide a visual animation of the digital asset at and/or between the neighboring points based on the waypoint scene model; Element 13: further comprising: creating a miniaturized version of the waypoint scene model corresponding to a diorama of the scene; and setting the virtual camera with respect to the scene model to provide a perspective view of the diorama; Element 14: wherein said augmented video data is provided with the one or more composited video frames with the diorama; Element 15: wherein said providing augmented video data comprises compositing one or more video frames provided by a video camera and the diorama to provide the augmented video data; Element 16: wherein the virtual camera is further set based on camera viewpoint data for the video camera to specify the perspective view of the diorama; Element 17: wherein the output device is a portable device and is one of a mobile phone, a tablet, a television (TV) device, and a laptop computer; Element 18: wherein the diorama is animated to provide a visual representation of the scene; Element 19: wherein the prop device is mobile phone, and the mobile phone is to provide the prop spatial data; Element 20: further comprising: receiving video data comprising video frames captured of a scene, the prop device being located in the scene; and compositing one or more video frames of the received video data and the digital asset with a position, a movement, and/or an orientation based on the updated spatial data for the digital asset; Element 21: wherein the compositing provides augmented video data, and the method further comprises causing the augmented video data to be rendered on an output device; Element 22: wherein the output device is one of a portable device and a camera viewfinder; Element 23: wherein the prop device is a first mobile phone, and the video data is provided by a second mobile device; Element 24: further comprising: receiving video data comprising video frames captured of a scene, the prop device being located in the scene; creating a miniaturized version of a scene model corresponding to a diorama of a scene; setting a virtual camera with respect to the scene model to provide a perspective view of the diorama; and causing the diorama of the scene to be outputted at the perspective view on an output device with the digital asset with a position, a movement, and/or an orientation based on the updated spatial data for the digital asset based on the prop spatial data; Element 24: wherein the causing comprises generating augmented video data comprising one or more composited video frames with the diorama; Element 25: wherein the generating augmented video data comprises compositing one or more video frames provided by a video camera and the diorama to provide the augmented video data; Element 26: wherein the virtual camera is further set based on camera viewpoint data for the video camera to specify the perspective view of the diorama; Element 27: wherein the camera is a first video camera, the output device is a first output device, the virtual camera is a first virtual camera, and the perspective view is a first perspective view, and the method further comprising: setting a second virtual camera in the virtual environment with respect to the scene model to provide a second perspective view of the diorama based on camera viewpoint data for a second video camera; and causing the diorama of the scene at the second perspective to be rendered on a second output device; Element 28: wherein the first and second output devices are mobile devices; Element 29: wherein the diorama is animated to provide a visual representation of the scene; Element 30: further comprising: receiving waypoint instructions identifying virtual points for the digital asset for a scene; updating a scene model to include the virtual points at locations in the scene model corresponding to locations in the scene; providing augmented video data comprising one or more composited video frames with the virtual points in the scene, the augmented video data being with the digital asset with a position, a movement, and/or an orientation based on the updated spatial data; and causing the augmented video data to be rendered on an output device; Element 31: further comprising receiving animation instructions identifying an animation of a digital asset between neighboring virtual points of the virtual points, the digital asset being animated between the neighboring virtual points based on the animation instructions; Element 32: wherein the providing comprises generating the augmented video data with composited frames with the virtual points in the scene and the digital asset between the neighboring virtual points; Element 33: wherein the causing comprises causing the augmented video to be rendered on the output device to provide a visual animation of the digital asset at and/or between the neighboring points at least based on the updated spatial data; Element 34: further comprising: creating a miniaturized version of the scene model corresponding to a diorama of the scene; and setting a virtual camera with respect to the scene model to provide a perspective view of the diorama; and Element 35: further comprising causing the prop device to provide the prop spatial device, wherein the prop device is a first mobile phone, and the video data is provided by a second mobile device.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The term “based on” means “based at least in part on.” The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 5-10% of the indicated number.

What has been described above include mere examples of systems, computer program products and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

The invention claimed is:

1. A computer-implemented method comprising:
providing a scene model that is a virtual representation of a scene based on depth and color data captured for the scene;
creating a miniaturized version of the scene model corresponding to a diorama of the scene;
setting a virtual camera with respect to the scene model to provide a perspective view of the diorama; and
causing the diorama of the scene to be outputted at the perspective view on an output device.

2. The computer-implemented method of claim 1, wherein said causing comprises generating augmented video data comprising one or more composited video frames with the diorama.

3. The computer-implemented method of claim 2, wherein said generating augmented video data comprises compositing one or more video frames provided by a video camera and the diorama to provide the augmented video data.

4. The computer-implemented method of claim 2, wherein the virtual camera is further set based on camera viewpoint data for the video camera to specify the perspective view of the diorama.

5. The computer-implemented method of claim 4, wherein the perspective view includes a top down view, an oblique view, or a slanted view.

6. The computer-implemented method of claim 4, wherein the camera is a first video camera, the output device is a first output device, the virtual camera is a first virtual camera, and the perspective view is a first perspective view, and the method further comprising:
setting a second virtual camera in the virtual environment with respect to the scene model to provide a second perspective view of the diorama based on camera viewpoint data for a second video camera; and
causing the diorama of the scene at the second perspective to be rendered on a second output device.

7. The computer-implemented method of claim 6, wherein the first and second output devices are mobile devices.

8. The computer-implemented method of claim 2, further comprising inserting one or more digital assets into the scene model representative of digital assets to be used in the scene.

9. The computer-implemented method of claim 8, wherein the one or more digital assets is a first digital asset, the method further comprising insert a second digital asset representative of an actor into the scene model, wherein movements of the second digital asset in the scene model are synced to movements of the actor.

10. The computer-implemented method of claim 1, wherein the diorama is animated to provide a visual representation of the scene.

11. A computer-implemented method comprising:
receiving waypoint instructions identifying virtual points for a digital asset for use in a scene;
updating a scene model to include the virtual points at locations in the scene model corresponding to locations in the scene to provide a waypoint scene model;
providing augmented video data comprising one or more composited video frames with the virtual points in the scene based waypoint scene model; and
causing the augmented video data to be rendered on an output device.

12. The computer-implemented method of claim 11, further comprising receiving animation instructions identifying an animation of a digital asset between neighboring virtual points of the virtual points, wherein the waypoint scene model is provided with data specifying the animation of the digital asset between the neighboring virtual points.

13. The computer-implemented method of claim 12, wherein said providing comprises generating the augmented video data with composited frames with the virtual points in the scene and the digital asset between the neighboring virtual points.

14. The computer-implemented method of claim 13, wherein said causing comprises causing the augmented video to be rendered on the output device to provide a visual animation of the digital asset at and/or between the neighboring points based on the waypoint scene model.

15. The computer-implemented method of claim 11, further comprising:
creating a miniaturized version of the waypoint scene model corresponding to a diorama of the scene; and
setting a virtual camera with respect to the scene model to provide a perspective view of the diorama.

16. The computer-implemented method of claim 15, wherein said augmented video data is provided with the one or more composited video frames with the diorama.

17. The computer-implemented method of claim 16, wherein said providing augmented video data comprises compositing one or more video frames provided by a video camera and the diorama to provide the augmented video data.

18. The computer-implemented method of claim 17, wherein the virtual camera is further set based on camera viewpoint data for the video camera to specify the perspective view of the diorama.

19. The computer-implemented method of claim 18, wherein the output device is a portable device and is one of a mobile phone, a tablet, a television (TV) device, and a laptop computer.

20. The computer-implemented method of claim 19, wherein the diorama is animated to provide a visual representation of the scene.
